(19) United States
(12) Patent Application Publication
(10) Pub. No.: US 2026/0343696 A1
(43) Pub. Date: Oct. 29, 2026

(54) Method for configuring and operating an LED driver

(71) Applicant: SlightLight AB, TÄBY (SE)

(72) Inventors: Manne TALLMARKEN, TÄBY (SE); Joel JAKOBSSON, STOCKHOLM (SE)

(21) Appl. No.: 19/695,027

(22) Filed: Jun. 2, 2026

Related U.S. Application Data
(63) Continuation of application No. PCT/SE2024/051005, filed on Nov. 27, 2024.

(30) Foreign Application Priority Data
Dec. 4, 2023 (SE) 2351390-6

(51) Int. Cl. H05B 45/10

(52) U.S. Cl. CPC H05B 45/10

(57) ABSTRACT

A method for configuring a Light Emitting Diode (LED) driver for dimming of an LED, the LED driver being arranged to provide a variable current which is modulated, using a transistor of the LED driver, based on a binary control signal having an instantaneous time-averaged value as time-averaged. The method comprises the following steps: providing the variable current with several different instantaneous time-averaged values; obtaining, for each of the several different instantaneous time-averaged values, a respective measurement value of an average current flowing through the LED or the load or an average light intensity emitted by the LED (10), thereby obtaining a measured first relationship; based on the first relationship, determining configuration information regarding a mapping of each of several different absolute or relative current/light intensity values to a corresponding value for the instantaneous time-averaged value; and storing the configuration information.

### BACKGROUND

The various embodiments of the present invention described herein relate to an LED (Light Emitting Diode) driver, as well as to a method for operating the same.

LED light sources are more energy efficient than many other types of light sources, such as halogen or incandescent light sources. During recent years, sales of LED light sources have therefore seen an increase. Concurrently, many resources have been put into the further development of the LED light sources themselves, as well as development of various ways of providing electric energy to LED light sources.

Normally, an LED light source is driven using a low DC voltage, such as a 12 V or 24 V DC voltage, the voltage being provided by a so-called LED driver. In order to control the luminous intensity of the LED light source, LED drivers usually control the power delivered to the LED light source by either controlling the voltage while keeping the current constant, or by controlling the current while keeping the voltage constant.

LED light sources are generally dimmable across a relatively broad spectrum of light intensities. However, it has proved difficult to provide an LED driver being able to dim LED light sources across very broad dimming intervals, such as all the way to complete darkness.

In particular, it is difficult to dim LED light sources across broad dimming intervals without taking into consideration the individual dimming behavior of LED light sources to be dimmed. It would be desirable to provide an LED driver that provides adequate dimming across broad dimming intervals for many different types of LED light sources.

Allowing a conventional LED driver to dim across such broad dimming intervals, it has been found that one or more of the following problems can occur: flickering light; disturbing sounds; increased wear on electric components; noticeable dimming steps and/or color shifts at low dimming powers; cable crosstalk; uneven or unpredictable lighting levels at different dimming settings and along a strip of LEDs (a “LED strip”); and high peak current requirements.

Some of these problems may be partly or completely overcome by selecting expensive or short-lived components.

Hence, it would be desirable to provide a low-cost LED driver having a long useful life and that avoids one or more of the above-mentioned problems.

### BRIEF SUMMARY

In one aspect, the invention relates to an LED, Light Emitting Diode, driver.

The LED driver can comprise a binary control signal source, arranged to provide a binary control signal as a square wave, the binary control signal having a control signal pattern that is repeated over time to form the binary control signal, the control signal pattern at each time having an instantaneous time-averaged value as time-averaged over the control signal pattern used at the time in question.

The LED driver can comprise a first-channel electric driver output, arranged to provide a drive current based on the binary control signal to drive an LED.

The LED driver can comprise a power transistor, having a power transistor control terminal and a pair of different terminals, one of the pair of different terminals being connected to the first-channel electric driver output.

The LED driver can comprise a drive circuitry, connected to the power transistor control terminal.

The drive circuitry can comprise a switch, arranged to provide an electric coupling between the power transistor control terminal to either a low voltage or a high voltage in dependence of an instantaneous low value or high value of the binary control signal.

The drive circuitry being arranged to receive or produce a level signal, the level signal being provided as an increasing or decreasing function of an increase in the instantaneous time-averaged value or as an increasing or decreasing function of an increase in a control signal in turn being correlated with the instantaneous time-averaged value.

The drive circuitry can further comprise a variable resistance part, arranged to provide a variable resistance along the electric coupling, the variable resistance varying as a function of the level signal, resulting in that an increase in the instantaneous time-averaged value results in an increase in an instantaneous current flowing to or from the power transistor control terminal.

In some embodiments, the drive circuitry comprises a signal averaging part, arranged to provide the level signal to be, or to correspond to, the instantaneous time-averaged value or to the inverse of the instantaneous time-averaged value.

In some embodiments, the signal averaging part comprises a low-pass filter or a digital to analog converting circuitry, arranged to provide the level signal as a smoothed and/or time-averaged version of the binary control signal, or to provide the level signal as a smoothed and/or time-averaged signal calculated based on the binary control signal, wherein a value of the level signal at a particular time is determined to correspond to a general level of the binary control signal at the same particular time.

In some embodiments, the level signal is a current or voltage corresponding to the instantaneous time-averaged value.

In some embodiments, the power transistor is a FET (Field-Effect Transistor).

In some embodiments, the switch comprises a switch transistor, having a gate/base terminal, a source/emitter terminal and a drain/collector terminal, the gate/base terminal of the switch transistor being connected to the binary control signal in the form of a voltage or current varying according to the value of the binary control signal.

In some embodiments, the switch comprises two switch transistors, a gate/base terminal of each being connected to the binary control signal in the form of a voltage or current varying according to the value of the binary control signal, the two switch transistors together providing a push/pull circuit.

In some embodiments, the two switch transistors are arranged between two different voltage potentials.

In some embodiments, the power transistor control terminal is coupled to a point between the two switch transistors.

In some embodiments, the switch transistor is a FET or a BJT (Bipolar Junction Transistor).

In some embodiments, the variable resistance part comprises a current-throttling part, arranged to throttle the current that can pass through the electric coupling and therefore limiting a rise-speed and/or fall-speed of an electric signal provided from the power transistor to the drive output as the switch switches the electric coupling between the low voltage and the high voltage.

In some embodiments, the variable resistance part comprises a current-controlling transistor, in turn comprising a current-controlling gate/base terminal, a current-controlling source/emitter terminal and a current-controlling drain/collector terminal.

In some embodiments, a current flowing through the electric coupling flows across the current-controlling transistor, via the current-controlling source/emitter terminal and the current-controlling drain/collector terminal.

In some embodiments, the level signal is coupled to the current-controlling gate/base terminal so that an increase in the instantaneous time-averaged value results in a higher instantaneous current across the current-controlling source/emitter terminal and the current-controlling drain/collector terminal.

In some embodiments, the current-controlling transistor is a BJT.

In some embodiments, the current-controlling transistor is series-connected to a first current-controlling resistor along the electric coupling.

In some embodiments, the variable resistance part comprises a first current-controlling transistor, connected so that a current flowing through the electric coupling between the first switch transistor and the power transistor control terminal passes through the first current-controlling transistor.

In some embodiments, the variable resistance part comprises a second current-controlling transistor, connected so that a current flowing through the electric coupling between the second switch transistor and the power transistor control terminal passes through the second current-controlling transistor.

In some embodiments, the binary control signal source is arranged to produce the binary control signal in response to an LED dimming value by varying both a pulse width and a number of pulses over the control signal pattern.

In some embodiments, the binary control signal source is arranged to produce the binary control signal in response to the LED dimming value by, when the LED dimming value increases, widening a pulse of the control signal pattern before increasing the number of pulses in the control signal pattern.

In another aspect, the invention relates to a method for driving an LED, comprising providing, to a driver output of the LED driver being connected to the LED, electric power, in turn causing the binary control source to provide the binary control signal and the power transistor to provide the drive current to the driver output.

In some embodiments, the method further comprises adjusting the binary control signal, thereby modifying the instantaneous time-averaged value.

In some embodiments, the method further comprises adjusting a dimming state of the LED driver; and mapping the adjusting of the dimming state to a corresponding adjustment of the binary control signal.

In another aspect, the invention relates to a method for configuring an LED, Light Emitting Diode, driver for dimming of an LED, the LED driver being arranged to provide a variable current to the LED, a time-average of the variable current corresponding to a dimming value, the variable current being modulated, using a transistor of the LED driver, based on a binary control signal, the binary control signal having a control signal pattern that is repeated over time to form the binary control signal, the control signal pattern at each time having an instantaneous time-averaged value as time-averaged over the control signal pattern; used at the time in question, the method comprising the steps providing, to a LED or a different load in turn being connected to the LED driver, the variable current with several different instantaneous time-averaged values for the binary control signal; obtaining, for each of the several different instantaneous time-averaged values, a respective measurement value of a quantity in turn being or being related to at least one of, firstly, an average current flowing through the LED or the load, and, secondly, an average light intensity emitted by the LED, thereby obtaining a measured first relationship of the absolute or relative current/light intensity as a function of the instantaneous time-averaged value; based on the first relationship, determining configuration information regarding a mapping of each of several different absolute or relative current/light intensity values to a corresponding value for the instantaneous time-averaged value; and storing the configuration information.

In some embodiments, the relative current and/or light intensity is relative to a maximum current or light intensity, respectively.

In some embodiments, the method further comprises identifying a second relationship between the instantaneous time-averaged value and the absolute or relative current/light intensity; identifying a parametric model of the second relationship, the parametric model comprising one or several at least section-wise continuous functions determined by a set of parameters, the parametric model being useful for determining the mapping of each of the several different absolute or relative current/light intensity values to a corresponding instantaneous time-averaged value; and determining values of the parameters that provide a fit of the at least one functions to the second relationship, the second relationship being evaluated for each of the measurement values and corresponding instantaneous time-averaged values.

In some embodiments, the configuration information comprises the parameter values.

In some embodiments, the second relationship comprises the quote or inverse quote of

$$\frac{g ( x )}{g ( y )} ,$$

wherein g is a function that is non-constant with respect to x; x is the instantaneous time-averaged value; and y is the absolute or relative current/light intensity.

In some embodiments, the one or several functions comprises at least one polynomial of degree 1 or higher.

In some embodiments, the one or several functions comprises one polynomial of degree 2 or higher.

In some embodiments, the one or several functions comprises two polynomials of degree 1 or higher that are interconnected by multiplication with a sigmoid function.

In some embodiments, the one or several functions are defined in terms of a function ƒ(y) where an absolute value of a first derivative of ƒ(y) with respect to y, in other words |ƒ′(y)|, is decreasing, wherein y is the absolute or relative current/light intensity.

In some embodiments, the one or several functions comprises a function defined in terms of two different polynomials and a sigmoid function multiplying together the two polynomials.

In some embodiments, the two polynomials are selected to approximate, by selection of the parameter values, a general shape of the second relationship on either side of a local minimum or maximum thereof.

In some embodiments, the sigmoid function is defined in terms of two functions s′ and s″ selected to yield a continuous function at an expected local maximum of the second relationship as a function of the absolute or relative current/light intensity, and so that a derivative of the continuous function does not change sign.

In some embodiments, the configuration information comprises respective determined and stored configuration information for at least one of firstly, at least two different number of pulses of the control signal pattern; secondly, at least two different temperatures of the LED driver when obtaining the measurement values; and thirdly, at least two different maximum allowed currents to be provided to the LED driver.

In another aspect, the invention relates to a method for operating an LED driver to drive an LED, the method comprising configuring the LED driver using a method of the above type; and operating the LED driver by determining a binary control signal corresponding to a desired current/light intensity, the determining of the binary control signal being performed using the configuration information, and providing a variable current to a driver output of the LED driver based on the determined binary control signal.

In some embodiments, the determining of the binary control signal comprises adjusting one or several pulse widths within the binary signal pattern.

In some embodiments, the determining of the binary control signal comprises adjusting a number of pulses within the binary signal pattern.

In some embodiments, the pulses within the binary signal pattern are adjusted so as to be distributed over a predetermined set of available pulse positions across the binary signal pattern.

In some embodiments, the determining of the binary control signal comprises determining a number of pulses within the control signal pattern; and to select the binary control signal according to an interpolation between a first and a second respective expression for the binary control signal.

In some embodiments, the first expression for the binary control signal is determined based on the configuration parameters for a first number of pulses within the control signal pattern.

In some embodiments, the second expression for the binary control signal is determined based on the configuration parameters for a second number of pulses within the control signal pattern.

In some embodiments, the interpolation is performed for a current number of pulses within the control signal pattern between the first number of pulses and the second number of pulses.

In some embodiments, the first and second expressions for the binary control signal are determined based on a respective pulse width within the control signal pattern.

In some embodiments, the interpolation is performed using as a weight factor, for the first and second expressions for the binary control signal, a square root of a normalized value for the current number of pulses.

The method also relates to an LED driver, comprising a first-channel electric driver output, the LED driver being arranged to provide a current to the first-channel electric driver output according to a first-channel binary control signal; and a first-channel timer function, the first-channel timer function being configured to update a first-channel timer counter variable at a first-channel timer frequency, the first-channel timer function being configured to, for each update, compare the first-channel timer counter variable to a set first-channel compare value, and the first-channel timer function being configured to, in case the first-channel timer counter variable has reached or gone past the set first-channel compare value, cause the first-channel binary control signal to switch between a first binary state and a second, different, binary state.

In some embodiments, a duration of a repeated first-channel control signal pattern of the first-channel binary control signal is longer than the time it takes for the first-channel timer counter variable to complete a full cycle, the first-channel control signal pattern comprising one or several pulses.

In some embodiments, the LED driver is arranged to update the set first-channel compare value at least two times during each individual first-channel control signal pattern.

In some embodiments, the first-channel timer frequency is at least as high as, or higher than, a predetermined clock frequency of a CPU comprised in the LED driver.

In some embodiments, the first-channel timer function uses a DLL, Delay Locked Loop, function, configured to divide a timer input clock period into several fractional steps.

In some embodiments, the first-channel timer function is cyclic.

In some embodiments, the LED driver further comprises a RAM, Random Access Memory, area; and a compare value copying function, operable to update the first-channel timer function with an updated set first-channel compare value from the RAM area.

In some embodiments, the compare value copying function is a DMA, Direct Memory Access, channel or an ISR, Interrupt Service Routine being executed in response to an IRQ, Interrupt Request.

In some embodiments, the compare value copying function is configured to react to an interrupt produced in connection to the first-channel timer counter value reaching its full cycle value, the reaction comprising copying a new first-channel compare value from a next or subsequent memory position of the RAM area.

In some embodiments, the DMA channel is configured to be circular, such that after it has reached the end of the RAM area it continues copying from a beginning of the RAM area again.

In some embodiments, a size of the RAM area is at least 4 compare values, such as at least 8 compare values, such as at least 16 compare values.

In some embodiments, the CPU is configured to, in reaction to an updated dimmer setting received by the LED driver, update the RAM area with an updated set of first-channel compare values specifically selected to reflect the updated dimmer setting.

In some embodiments, an individual pulse of the binary control signal is longer than the time it takes for the first-channel timer counter variable to complete a full cycle.

In some embodiments, the LED driver is arranged to vary a number of pulses provided across the first-channel control signal pattern so as to achieve different desired instantaneous time-averaged values of the first-channel control signal pattern.

In some embodiments, the LED driver is arranged to vary a respective pulse width of one or several of a set of one or several pulses provided across the first-channel control signal pattern so as to achieve different desired time-averaged currents provided to the first-channel electric driver output.

In some embodiments, the LED driver is arranged to gradually increase the time-averaged applied current to the first-channel electric driver output by first increasing a pulse width of one or several pulses provided across the first-cannel control signal pattern and to thereafter increase a number of pulses provided across the first-channel control signal pattern.

In some embodiments, the LED driver is arranged to distribute the at least one pulse across the first-channel control signal pattern over a set of predetermined and distributed time pulse positions across the first-channel control signal pattern.

In some embodiments, the distribution takes place according to a bit-reversal of a binary representation of a number, the number in turn describing or corresponding to the index of the pulse within the first-channel control signal pattern.

In some embodiments, a duration of the first-channel control signal pattern is constant across different desired time-averaged currents provided to the first-channel electric driver output.

In some embodiments, the LED driver comprises, in addition to the first-channel electric driver output, a second-channel electric driver output, the LED driver being arranged to provide a current to the second-channel driver output according to a second-channel binary control signal; and a second-channel timer function, the second-channel timer function being configured to update a second-channel timer counter variable at a second-channel timer frequency, the second-channel timer function being configured to, for each update, compare the second-channel timer counter variable to a set second-channel compare value, and the second-channel timer function being configured to, in case the second-channel timer counter variable has reached or gone past the set second-channel compare value, cause the second-channel binary control signal to switch between a third binary state and a fourth, different binary state.

In some embodiments, a duration of a repeated second-channel control signal pattern of the second-channel binary control signal is longer than the time it takes for the second-channel timer counter variable to complete a full cycle, the second-channel control signal pattern comprising one or several pulses.

In some embodiments, the LED driver is arranged to update the set second-channel compare value at least two times during each individual second-channel control signal pattern.

In some embodiments, a duration of the first-channel control signal pattern is an integer multiple of, such as the same as, a duration of the second-channel control signal pattern.

In some embodiments, the first-channel binary control signal is time-offset in relation to the second-channel binary control signal by an offset value that is smaller than the first-channel control signal pattern.

In some embodiments, the LED driver comprises three or more electric driver outputs, the LED driver being arranged to apply a respective current to each such driver output according to a respective binary control signal.

In some embodiments, each of the binary control signals has a respective repeated control signal pattern, the duration of which is an integer multiple or fraction of, such as the same as, each of the duration of repeated control signal patterns of the other binary control signals.

In some embodiments, the LED driver is arranged to time-offset each of the binary control signals by a value lower than the duration of the first-channel control signal pattern.

In some embodiments, the respective time-offsets of the at least three control signal patterns are distributed over a set of predetermined and distributed time offsets across the first-channel control signal pattern.

In some embodiments, the respective time-offsets of the at least three control signals are different.

In some embodiments, the time-offsets are computed according to a bit-reversal of a binary representation of a number, the number in turn describing or corresponding to the index of the respective electric driver outputs.

In some embodiments, the time-offsets are scaled over a duration of the first-channel control signal pattern.

In some embodiments, a clock frequency of the first-channel timer function is at least 50 MHz, such as at least 100 MHz, such as at least 150 MHz.

In some embodiments, the LED driver is a constant-voltage LED driver.

In some embodiments, the first-channel binary control signal is arranged to switch between the first binary state and the second binary state and back to the first binary state again at a frequency of at least 20 kHz, preferably at least 25 kHz.

In some embodiments, the LED driver further comprises a DC bus, the DC bus comprising a ceramic capacitor.

### BRIEF DESCRIPTION OF THE SEVERAL VIEWS OF THE DRAWINGS

FIG. 1a is a chart showing a current as a function of a voltage;

FIG. 1b is a chart showing a log current as a function of a voltage, the current and voltage corresponding to those shown in FIG. 1a;

FIG. 1c is a chart showing several different log currents as a function of a voltage;

FIG. 2 is an overview of an LED driver;

FIG. 3 is a flowchart showing an interrelationship between a first aspect, a second aspect and a third aspect;

FIG. 4a is a chart showing a voltage-signal pulse train with straight flanks;

FIG. 4b is a chart showing a voltage-signal pulse train with slanting flanks;

FIG. 4c is a series of charts, going from the topmost chart to the lowermost chart, showing a progression of a pulse train design for an increasing PWM-like duty cycle;

FIG. 4d is a principle graph of a pulse with definitions;

FIG. 5 is an overview of an LED driver;

FIG. 6 is a chart illustrating an order according to which different pulses are introduced in a pulse pattern;

FIG. 7 is a flowchart illustrating how to introduce pulses in a pulse pattern;

FIG. 8 is a chart showing a light intensity as a function of a PWM-like duty cycle;

FIG. 9 is similar to FIG. 8, but shows the information in a log-log chart;

FIG. 10 is a chart showing a curve fitting, together with a chart showing a sigmoid function;

FIG. 11 is a flowchart for operating an LED driver;

FIG. 12 is an overview chart illustrating an LED driver configuration setup;

FIG. 13 is a chart showing an alternative sigmoid function;

FIG. 14 is a flowchart for operating an LED driver;

FIG. 15 is an overview of an LED driver connected to an LED load;

FIG. 16 is an overview of an LED drivers;

FIG. 17 is a circuit diagram showing a push-pull circuit;

FIG. 18 is a circuit diagram of an LED driver;

FIGS. 19 and 20 are a series of circuit diagrams illustrating an analysis of part of the circuit diagram of FIG. 18;

FIG. 21 is a chart showing a curve set of voltages as a function of an output voltage and of a temperature;

FIG. 22 is a chart showing a curve set of voltages as a function of an output voltage and of a resistance;

FIG. 23 is an overview of an LED driver;

FIG. 24 is a circuit diagram of an LED driver;

FIG. 25 is a circuit diagram of an LED driver;

FIGS. 26a and 26b shows the shape of a respective voltage pulse as a function of time; and

FIG. 27 is a flowchart for operating an LED driver.

The Figures share the same reference numerals for same or corresponding parts. Some reference numerals are used with or without one or several apostrophes, where the reference numeral without any apostrophe refers to the part in general whereas a number of apostrophes after the reference numeral denotes a particular channel. For instance, the LED drive switch is generally referred to as 180 whereas 180″ refers to the LED drive switch for a second channel.

### DETAILED DESCRIPTION

The behavior of any particular LED light source may be difficult to foresee across a wide range of driving powers. In particular, dimming behavior may not be linear, or it may even be undefined.

To understand this, one can investigate the behavior in terms of light power as a function of voltage for an LED connected in series with a current-limiting resistor, which is a common setup. The current through an LED is described by Shockley's diode equation:

$${I}_{D} = {I}_{s} [ exp ( \frac{{V}_{D}}{n {V}_{T}} ) - 1 ] ,$$

wherein I_{D} is the current through the diode, I_{S} is the current scale factor, V_{D} is the voltage, V_{T} is the thermal voltage and n is the ideality factor. For LEDs, I_{S} is normally in the order of nA, making the exponential term dominating for normally occurring currents I_{D}. The expression can therefore be simplified to

$${I}_{D} = {I}_{s} \cdot exp ( \frac{{V}_{D}}{n {V}_{T}} ) ,$$

And, solving for V_{D}:

V_{D}=nV_{T}·ln(I_{D}/I_{S}).

As an example of how the current varies through an LED that is connected in series with a resistor, a typical LED can be observed having a maximum forward current of 0.03 A. The LED used in this example is an NSPW500BS sold by Nichia. The parameter values can easily be read in the software program LTSpice, resulting in I_{S}=0.27 nA and n=6.79. The thermal voltage V_{T} is obtained by the expression V_{T}=kT/q, where k is the Boltzmann constant, T is the absolute temperature and q the elementary charge. In room temperature (300 K), this equation yields V_{T}=25.852 mV.

This, in turn, results in

$${V}_{D} = n {V}_{T} \cdot ln ( {I}_{D} / {I}_{S} ) \approx 0.1755 \cdot ln ( \frac{{I}_{D}}{0.27 \cdot {10}^{- 9}} ) .$$

At 0.03 A, V_{D}=3.25 V. If the series-connected LED and resistor are driven at 5 V, 1.75 V will be across the resistor at nominal current, which yields the resistance R=U/I=1.75/0.03=58.3Ω. The equation for the voltage given the diode current therefore becomes

$$U = {V}_{D} + {I}_{D} \cdot R = 0.1755 ln ( \frac{{I}_{D}}{0.27 \cdot {10}^{- 9}} ) + {I}_{D} \cdot 58.3 .$$

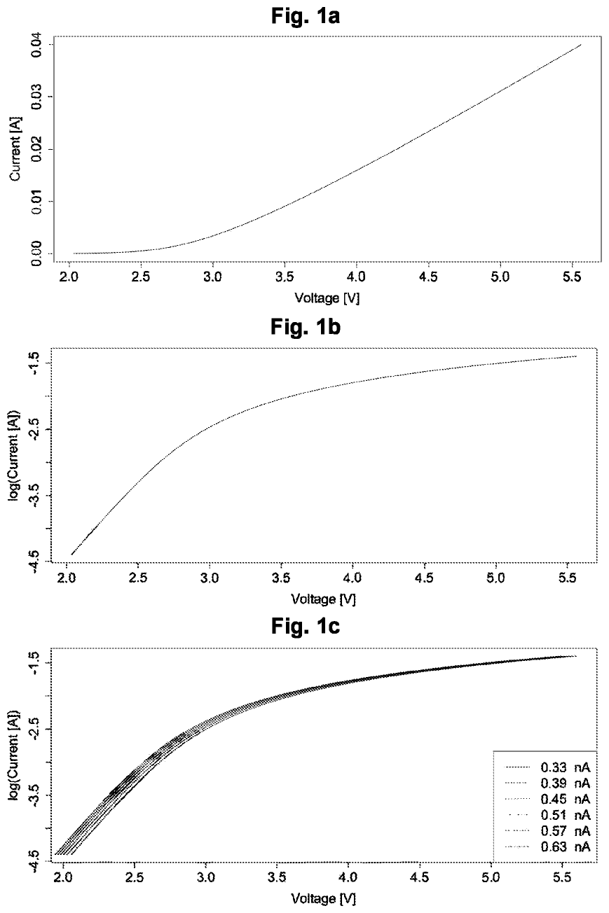

A plot of this equation can be seen in FIG. 1a, and a version with log-scale current is shown in FIG. 1b. It can be seen that the graph has an approximately exponential region, because of the LED, and an approximately linear region, due to the resistor. The light power from an LED is proportional to the current, and the human eye has higher sensitivity at lower light levels.

In the calculations above, all the physical constants were approximations. Fluctuations during manufacturing will cause the parameter values to shift from diode to diode, causing the resulting LEDs to have not the exact same properties and characteristics. FIG. 1c shows the result after shifting the ingoing parameter values slightly. From this FIG. 1c, it is clear that the fluctuations become more noticeable at lower voltage levels. For an LED strip comprising many individual LEDs, this means that the LEDs will start to shine differently as the voltage drops, which is not desirable.

To solve this problem, one can measure the properties of each LED precisely during or after manufacturing and only use similar-properties LEDs together. This is called “binning” and is fairly expensive. Instead, one can avoid using the LEDs at lower voltage levels but instead always use higher voltage levels, such as full power.

In the latter case, conventional LED drivers use switching patterns to dim LED light sources, switching the LED light source in question on and off rapidly at high enough frequencies so that the human eye is incapable of noticing the resulting flickering. Such driving using a pulsed power provides a perceived more uniform dimming behavior for a wide range of LED light sources having different properties. Such LED drivers are called “constant voltage” drivers.

One way of providing such pulsed power to an LED light source is by the LED driver using pulse width modulation (PWM). A PWM signal can be described in terms of the pulse width and period time (both measured in seconds), or alternatively in terms of its frequency (measured in Hz) and duty cycle (the pulse width in relation to the period time, measured as a percentage).

In microcontroller-based PWM drivers, a timer may be used that counts the number of clock cycles and that compares this number to a certain compare value. As long as the counter is below the compare value, the output signal is high (such as a predetermined full LED power); and when the timer exceeds the compare value, the output signal becomes low (such as zero LED power). The timer is then reset as the period time is reached. Hence, the time resolution of the PWM driver is determined by the clock frequency of the timer, and the PWM frequency is the clock frequency divided by the period length (measured in number of clock cycles). For instance, if a timer having a clock frequency of 25 MHz uses a period of 100,000 steps (clock cycles), a PWM signal is generated having a period frequency (PWM frequency) of 25·10⁶/10⁵=250 Hz The time resolution is 1/(25·10⁶)=40 ns. In this case, the smallest duty cycle achievable is for compare value=1, and the duty cycle is then 1/1e5=0.001%.

The human eye has higher sensitivity at low lighting levels, meaning that it is the relative change of the light intensity which is important to the sensation of light. A change from 100% light intensity to 10% light intensity is experienced as roughly equally large as a change from 10% to 1% light intensity. In other words, an LED driver dimming from 100% to 1% time-averaged light intensity is perceived to dim the LED light source twice as “far” as an LED driver dimming from 100% to 10%.

At the same time, the human eye can perceive light in very small quantities. For instance, it has been found that light emitted from an LED light source of nominal current at 200 mA can be perceived when the LED light source is driven with as little as 5 μA total current, which is 40,000 time less than the nominal current.

In order to dim such an LED light source down to such low emitted powers using PWM, a duty cycle of 0.0025% would be required. If this number is rounded down to 0.001%, this then means that a microcontroller with a clock frequency of 25 MHz using a PWM frequency of 250 Hz would barely be able to achieve such low dimming levels.

However, even if such low dimming would be possible, the step from the lowest dimming level to the second-lowest dimming level would be 100%, which would be a very noticeable step in light intensity to the human eye. In particular, this would be visible when using color-settable lighting (such as an RGB-controlled lighting), since the color would change significantly by dimming one of the color channels up or down close to the lowest possible dimmer setting.

It has been shown that the human eye is incapable of sensing a light intensity change of less than about 1.5%. Therefore, if an LED driver is to be able to dim all the way down to darkness and be perceived as dimming continuously over the whole dimming intensity interval, all dimming steps across the whole intensity interval must be less than 1.5%. If the maximum step size is set to 1% for margin, such 1% steps need to be taken at 0.001% light intensity close to the lower-most dimming levels. This means that the light intensity resolution needs to be at the most 0.00001% at these levels.

Producing short PWM pulses furthermore results in wavelengths that risk being of the same magnitude as an LED strip in which the controlled LED is used. LED strips tend to be at the most 5 m-10 m long, in order to avoid intolerable voltage drops across the LED strip. The speed of light in copper is about half of that in vacuum, meaning that a pulse of 40 ns into an LED strip will have a pulse length of roughly 6 m:

(s=vt=150·10⁶·40·10⁻⁹=6m).

6 m is the same order of magnitude as the length of a typical LED strip. Since the pulse length is comparable to the length of the LED strip, this means that the load must be modelled using microwave theory rather than traditional voltage equations. In other words, the generated pulse will to some extent be reflected at the end of the LED strip, and the pulse together with its reflection will risk creating standing wave patterns along the LED strip. This, in turn, means that the applied voltage will not be uniform along the LED strip and the individual LEDs will shine with different power depending on the applied voltage pulse characteristics.

At the same time, it is also necessary to avoid visible flickering as well as sounds accruing from the driver or any power source used. Since PWM by definition involves flickering, the flickering needs to be kept at frequencies not perceived as disturbing. This is done by using sufficiently high PWM frequencies.

The standard IEEE PAR1789 (“IEEE Recommended Practices for Modulating Current in High-Brightness LEDs for Mitigating Health Risks to Viewers”) defines “flicker-safe” driving of a load alternating between 0% and 100% as using a driving frequency of at least 3 kHz. The disturbing effect of flickering as perceived by humans decreases with decreasing average light intensity. The present inventors have noted that it is not as critical to stay above 3 kHz frequencies when operating close to the lowest dimming intensities for drivers capable of dimming to complete darkness.

At 3 kHz PWM frequency and 0.001% duty cycle, the pulse width becomes very short; 0.001% of a period time of 333 μs is 3.33 ns. This is equivalent to a PWM frequency of 300 MHz, and for a square wave preserving its first overtones this implies frequencies in the GHz range. At such high frequencies, the wavelengths become so short that the voltage supply cable starts acting as an antenna, potentially resulting in crosstalk with nearby cables. Problems with standing waves in the voltage supply cable may also accrue, resulting for instance in an LED light strip supplying different light intensities along different parts thereof.

To mitigate these problems, it is possible to remove the sharp current derivatives of the PWM signal, resulting in the highest frequencies are decreased or eliminated. However, this means that the LED light source will spend more time in total in the voltage interval between 0 V and nominal voltage (for instance, 12 V or 24 V). As the behavior of the LED light source may be undefined in this interval, uneven light may result during dimming. Therefore, for an LED light source to work acceptably at a PWM signal of 3 kHz and a duty cycle of 0.001%, the light intensity emitted by different LEDs in the same LED light source (or “LED load”) should preferably have the same behavior in terms of light output as a function of time-averaged current in the interval from 0 V up to its nominal voltage. This is possible, but then conventionally requires careful binning of the LED light sources to use with one and the same LED driver, in order to minimize the differences of their forward voltages.

For higher light intensities, however, the current derivatives will only contribute to a very small share of the total light, why any differences between individual LED light sources become unnoticeable far from the lowest dimming intensities.

For many LED drivers, unwanted noise becomes a problem as the delivered power varies. For instance, a constant voltage LED driver will draw a varying current as the delivered power varies, resulting in that any capacitors and inductors in a power supply used may start emitting sound. If the PWM frequency is within the human-hearable sound frequency spectrum, such sounds may become noticeable when the current requirements are high enough.

By using a PWM frequency exceeding about 25 kHz, any resulting noise will not be noticeable to the human ear. Such high PWM frequencies also make it possible to use chip capacitors while still providing sufficient capacitance to draw relatively smooth currents, in turn resulting in smaller current and voltage variations for the power supply. Smaller voltage variations means that any electrolyte condensers in the power supply are not loaded as heavily during operation, effectively prolonging their useful life.

For these reasons, a PWM frequency of at least 25 kHz is advantageous so long as the LED light source draws a non-negligible current. Instead, ceramic capacitors, typically associated with a long useful life, can then be used if high PWM frequencies are selected.

The LED driver embodiments described herein may be constant-voltage LED drivers. They can be used to drive individual LEDs and/or LED strips, for instance at 12 V or 24 V constant voltage. An LED strip is typically up to a maximum of 5 m or 10 m, and can comprise a plurality of individual LEDs that in turn can be connected in series to one or several resistors. Groups of one or more individual LEDs in an LED strip can be connected in parallel, allowing a user to adapt the total length of the LED strip by cutting it at predetermined points along the length of the LED strip.

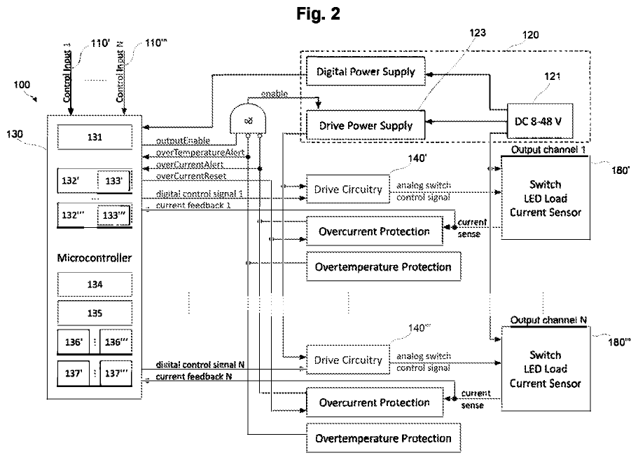

FIG. 2 illustrates an exemplary LED driver 100 having N channels. That the LED driver has N channels means that it can concurrently drive N LED loads, such as N different LEDs and/or LED strips. The drive of the channels can take place in an independent manner, so that each channel can be dimmed independently of the other channels. For multi-color LEDs, different colors can be controlled over different channels, with an RGB (Red Green Blue) LED as an example. As an example, the LED driver 100 can have twelve channels, but it is realized that the number of channels in various embodiments can be at least one, at least two, at least four, or at least ten; and/or that the number of channels can be at the most one hundred, at the most fifty, or at the most twenty.

The LED driver 100 comprises a microcontroller 130, arranged to accept a respective control input 110′, 110″, 110′″ for each of the N channels. Each such control input 110′, 110″, 110′″ can be in the form of a digitally coded number or an analog signal representing a desired dimming value for the channel in question.

The microcontroller 130 comprises a CPU 131 and/or other hardware computational logic circuitry component, such as a GPU. The microcontroller 130 can further comprise a respective timer function 132′, 132″, 132′″ for each of the channels. Each such timer function 132′, 132″, 132′″ can in turn comprise a respective DLL (Delay Locked Loop) function 133′, 133″, 133′″. The microcontroller 130 can further comprise a RAM (Random Access Memory) area 134 and/or a compare value copying function 135. For each of the channels, the microcontroller 130 can comprise a respective binary control signal generator 136′, 136″, 136′″ and/or a respective pulse compensator 137′, 137″, 137′″. These components will be described in closer detail below.

The LED driver 100, and in particular the microcontroller 130 can comprise a piece of control software, arranged to execute on the CPU 131 and/or any other computational hardware component of the microcontroller 130 and when executed perform the steps described herein performed by the microcontroller 130. One or several of the steps described herein can also be performed using purely hardware-based logic, as the case may be. Each of the components 132, 135, 136 and 137 can be implemented as discrete hardware components; as software modules; or a combination. The LED driver 100 can also comprise a communication bus for communication between the various hardware and software components of the LED driver 100 described herein.

The LED driver 100 furthermore comprises, or is connected to, an internal or external power supply 120. The LED driver 100 can further comprise a DC bus 121, that in turn can provide a constant voltage of at least eight volts and/or at the most 48 volts. The power supply 120 can be arranged to, via the LED bus 121, power the microcontroller (such as using 3.2 V) and/or an LED drive switch 180′, 180″, 180′″ of the LED driver 100 (such as at 5.0 V). One such LED drive switch 180′, 180″, 180′″ for each channel is arranged to provide a variable current to a respective driver output corresponding to the channel in question. The time-average of the variable current corresponds to the desired dimming value for that channel. The DC bus can comprise a ceramic capacitor.

The LED driver 100 can also comprise a respective drive circuitry 140′, 140″, 140′″ for each channel. The drive circuitry 140 is arranged to provide an analog switch control signal to the LED drive switch 180 to control the LED drive switch 180 to in turn provide the drive current to the LED driver output. The drive circuitry 140 can comprise software-implemented functionality, but in examples the functionality of the drive circuitry 140 is entirely or at least partly implemented in hardware.

The LED driver 100 also comprises functionality for overcurrent and overtemperature protection. Such functionality is conventional as such and will not be described in detail herein.

The present inventors have developed the LED drivers described herein according to three aspects, that can be used independently or combined freely.

In a first aspect, pulses generated by the microcontroller 130 have a dynamic frequency such that low frequencies are used for low intensities and high frequencies are used for higher intensities.

In a second aspect, a model is formulated allowing a mismatch to be decreased between expected light intensity and actual light intensity.

In a third aspect, the drive circuit 140 is devised having a dynamic rise and fall time, such that smooth pulses with long rise and fall times are used for low intensities while faster pulses with shorter rise and fall times are used for higher intensities.

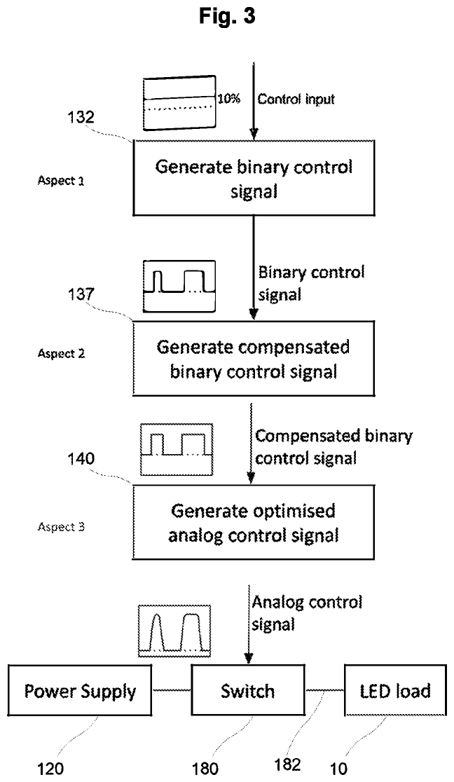

The interrelationship between these aspects is illustrated by means of a simplified overview shown in FIG. 3.

Starting from the top of FIG. 3 and moving downwards, a control input is generated, identified or received by the microcontroller 130. The control input can be an analog or digital signal on any suitable format that can be interpreted by the microcontroller 130. Generally, the input signal can be significative of a desired dimming level, such as on a scale from 0% (no light emitted from the LED) to 100% (full light). In the example shown, the control value received by the microcontroller 130 signifies “10% dimming level”.

Functionality according to the first aspect then produces a pulsed signal corresponding to the control input. More particularly, the pulsed signal is a periodic binary signal generated by one or several timer functions 132 of the microcontroller 130. The periodicity of the periodic binary signal can coincide with a lowest supported frequency of the microcontroller 130, and a highest supported frequency of the microcontroller 130 can be a multiple of this lowest supported frequency. In examples, the lowest supported frequency is 250 Hz and the highest supported frequency is 32 kHz.

Herein, such a produced periodic binary signal is generally denoted “binary control signal”. A binary control signal can be in the form of a square wave comprised of an alternating low and high value, such as 0 and 1. The binary control signal can have a control signal pattern, in other words a binary pattern that is repeated over time to form the binary control signal. At each given point in time, the control signal pattern has an instantaneous time-averaged value. This instantaneous time-averaged value is a value determined as the time-averaged value over the control signal pattern used to form the binary control signal at the time of determination. The control signal pattern can change over time, for instance in reaction to a changed control input. In some embodiments, the (potentially over time changing) repeated control signal pattern fully defines the binary control signal over time, such that the binary control signal does not comprise any additional waveforms in addition to the repeated control signal pattern. At any rate, the control signal pattern can be arranged to completely determine an instantaneous time-averaged value of the binary control signal at all times.

As is shown in FIG. 3, the generated binary control signal can comprise pulses of different pulse widths. Generally, the control signal pattern can comprise one or several pulses, each having the same or different pulse widths, and/or the time between individual pulses can be the same or different. This way, the produced binary control signal has similarities to a PWM signal, but can be more complex than a conventional PWM signal. In some embodiments, the binary control signal has a duration of at least 0.1 ms, such as at least 0.5 ms, such as at least 1 ms, or even at least 2 ms. In some embodiments, the binary control signal has a duration of at the most 1000 ms, such as at the most 500 ms, such as at the most 100 ms, such as at the most 50 ms, such as at the most 20 ms, or even at the most 10 ms.

Functionality according to the second aspect, and in particular a pulse compensator 137 of the microcontroller 130, can then produce, based on the binary control signal, a compensated binary control signal. This compensation can then take into consideration a determined model of properties of at least one of the drive circuitry 140, the LED drive switch 180, the LED load 10 actually powered by the LED driver 100, and a predetermined typical LED load to be powered by the LED driver 100.

More particularly, as any pulse rise or fall time has a non-zero width for any drive circuitry, the actual relative current drawn from an LED load will not perfectly match the average duty cycle of the binary control signal. If the instantaneous pulse frequency of the binary control signal is increased while the average PWM-like duty cycle is kept constant, the pulse widths become narrower and the rise and fall times will have a larger impact on the overall match between average duty cycle and average relative current drawn from the LED load 10. The model can therefore be devised to approximate an inverse model of the drive circuitry 140 such that the compensated signal compensates for the particular behavior of the drive circuitry 140 (and correspondingly for the LED drive switch and the LED load 10 or typical LED load).

As is shown in FIG. 3, the compensated binary control signal can have a format that corresponds to the uncompensated binary control signal, such as having straight flanks (it can be a purely binary signal), but the pulse configuration can be altered for instance in terms of individual pulse widths in the control signal pattern.

Maintaining even light intensity over the whole length of an LED strip at low light intensities requires that the pulses be physically much longer than the LED strip itself. Thus, too short pulse widths cannot be used and so the pulses must be longer while at the same time not contributing to too much light. If the rise and fall times are longer, the pulses get wider while not contributing to maximum power output. However, for higher currents and higher frequencies, this results in more power dissipation than necessary. Functionality according to the third aspect, and more particularly the drive circuitry 140, provides the analog control signal as a (not purely binary) signal having dynamic rise and fall times that depend on the instantaneous time averaged value of the binary control signal.

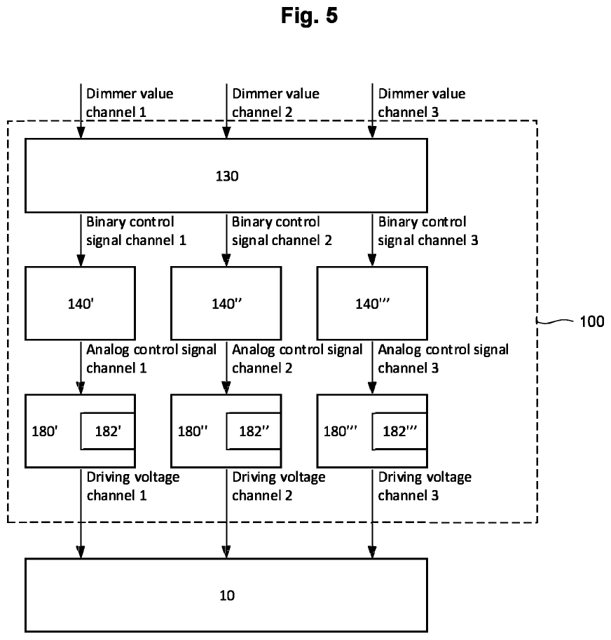

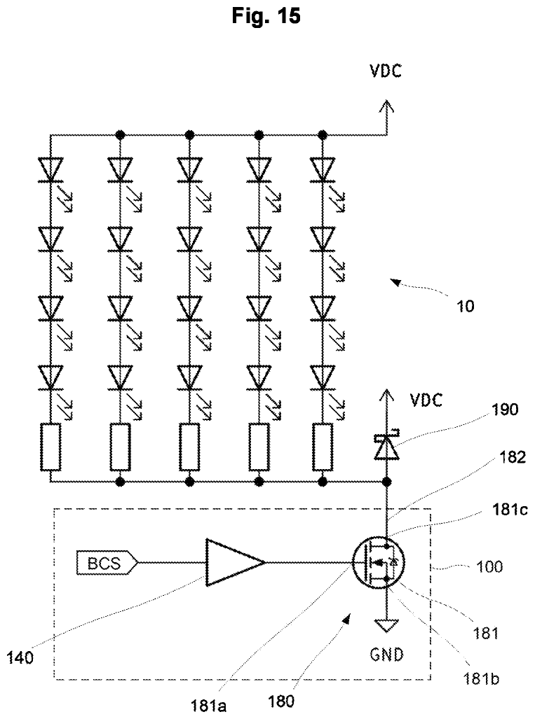

The analog control signal is then provided to the LED driver switch 180, the latter producing the current at the LED driver output 182 (see FIG. 5 and FIG. 15) to be provided to the LED load 10. The current is provided using the power supply 120. The average current provided to the LED load 10, relative to a maximum current, can be the input to the control input 110 to the LED driver 100.

It is realized that each of the first, second and third aspects provide different advantages in terms of a final pulsed current provided to the LED load 10, but that all three aspects are not necessary in all embodiments. In particular, the first, second and third aspects can be used individually or be combined in pairs of two, or all three, to provide various advantages as described herein and as is desired or needed in the particular use case considered. For instance, the control input can be in the form of a PWM-like signal provided directly to the functionality according to the second aspect. The binary control signal can be used as it is and provided directly to the functionality according to the second aspect. The compensated control signal can be provided directly to the LED driver switch 180. And so on.

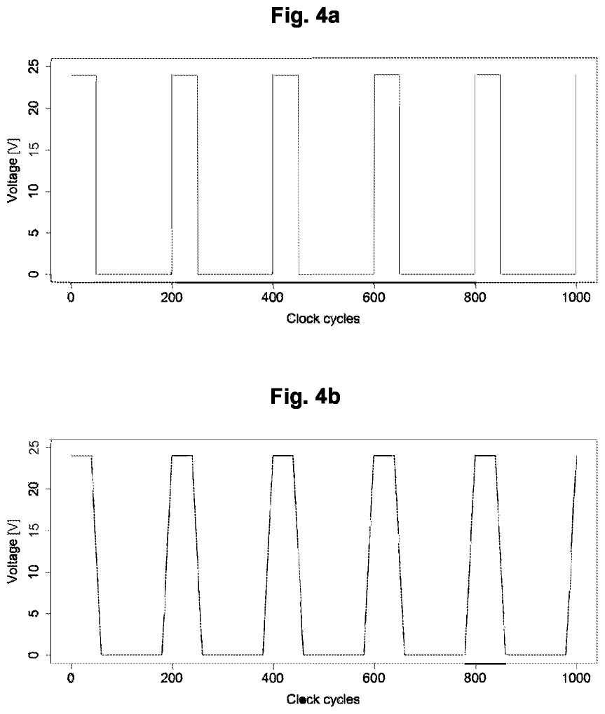

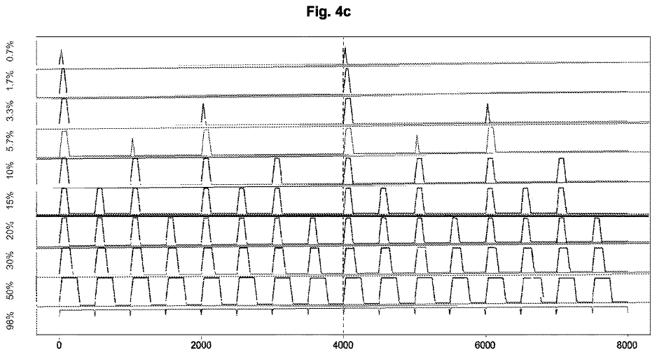

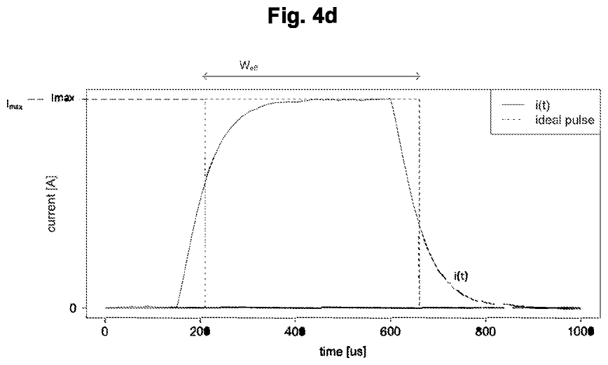

FIG. 4a shows an exemplary binary control signal, in the form of a square voltage (Y axis) wave shape as a function of time (X axis), the wave shape alternating between a low value (in this case 0 V) and a high value (24 V). The binary control signal is arranged to control an on/off or high/low state of an LED load, such as an individual LED light or an LED strip as described above. It is realized that the binary control signal can alternatively be an electric current signal. Furthermore, the signal shown in FIG. 4a is an analogue signal, but it is realized that the binary control signal in some embodiments can be a coded signal, such as a digitally coded signal conveying the corresponding wave shape information. The binary control signal can also be digitally generated by a timer 132 of the microcontroller 130, and output as an analog signal of the type shown in FIG. 4a.

For a binary control signal in the form of a repeated square wave shape having only one pulse, the pulse width divided by the period width is the percentage time that the binary control signal is active. As discussed above, this is called the duty cycle, for instance in PWM. In the example provided in FIG. 4a, the pulse width is 60 clock cycles and the period time is 200 clock cycles, yielding a duty cycle of 60/200=30%. The frequency is provided as the inverse of the period time. Timers that are integrated in conventional microcontrollers typically use an internal clock to count the number of clock cycles until a desired maximal counter value is achieved, after which the counter is restarted. The counter value is compared to a compare value and the microcontroller generates a signal which is high if the counter is under the compare value but low if the counter is over the value, resulting in a PWM signal.

The time resolution of this signal is determined by the speed of the internal clock: the faster the clock counts, the more frequent the possibility of changing the signal from low to high or vice versa. Most conventional microcontrollers use a main clock that can be scaled down to generate the timer clock. Recent microcontrollers, however, sometimes have timers that use delay locked loops (DLLs), in effect providing the same effect as scaling up the main clock.

In embodiments of the present invention, the LED driver 100 can be a constant-voltage LED driver, arranged to drive an LED load 10 at a constant voltage. Instead of varying a current smoothly to achieve various dimming levels, the LED driver 100 can be arranged to provide a voltage signal switching from zero to the notional constant voltage (such as 12 V or 24 V), of from some other low value above zero to the notional constant voltage. The switching can then take place according to a square wave signal such as the one shown in FIG. 4a, or according to such a square wave signal that has been compensated and/or modified as described in connection to the various embodiments described herein. It is realized that this also means that a drive current provided to the LED load 10 will be a varying (pulsed) current, as a result of the voltage switching between its low value and its high value.

As mentioned above, there is a problem generating very low light levels in an LED load 10 using a PWM approach, both since the dimming step size at very low light levels becomes relatively large even with a fast microcontroller, and also because very short pulses yield problems with standing waves along a driven LED strip.

Another thing to consider is how the voltage supplied to the LED load 10 changes over time, in other words the voltage derivative when switching from the low value to the high value and vice versa. This is illustrated in FIG. 4b, which corresponds to the wave shape shown in FIG. 4a but shows a varying voltage applied to an LED load 10 by the LED driver 100.

As is clear from FIG. 4b, the voltage takes a while to change from the low value to the high value and vice versa, causing the LED load 10 to emit light before the rising voltage has reached its maximum level, and correspondingly before the sinking voltage has reached its minimum level. The properties of this voltage derivatives at the flanks of the voltage provided to the LED load 10 affects the behavior of the LED load 10 in terms of light emitted at low dimming values. The challenge is to cause the LED driver to achieve even and smooth lighting at low dimming values both in terms of the dimming behavior of each individual LED light and light emitted along the LED strip.

Embodiments of the present invention solves this problem by defining a lowest acceptable PWM frequency to use at low light levels allowing a sufficiently wide pulse width to achieve a particular defined low average light power over time without noticeable pulse flank effects due to the voltage derivatives. Dimming up the light power from a low or lowest dimming value, the pulse width can first be increased up to a certain pulse width at which the flank effects are negligible in relation to the duty cycle, and at that point another pulse can be introduced in the repeated pulse pattern. The newly added pulse can have a pulse width which is narrower than the already-existing pulse. It is understood that this signal is then no longer a PWM signal, but a more complex signal.

The pulse width of the newly added pulse can then be increased as the dimming value is increased, up until the certain pulse width, whereupon an additional pulse can be added, and so on.

Once a desired maximum number of pulses has been reached in the repeated control signal pattern, the pulse widths of all the pulses can be grown in concert to further increase the dimming value up until a full-light point where the pulses completely fill the signal and the signal de facto is at its high value 100%, or close to 100%, of the time.

FIG. 4c illustrates an example of how this can be achieved. Each row in FIG. 4c illustrates two full cycles (each 4,000 μs long) of the repeated waveform signal provided to the LED load 10, where the dimming value is increased from the top to the bottom row. The voltage derivatives are slightly exaggerated for reasons of clarity. Each row in FIG. 4c is denoted using an instantaneous time-averaged control signal pattern value of the row in question, as marked to the left in the chart. The X axis in FIG. 4c represents clock cycles.

In the first waveform, a 250 Hz signal is introduced. Since the derivative is limited and the pulse is short, the pulse does not have the time to reach the high value of 24 V before the pulse ends. However, as the dimming value increases, the voltage at the pulse peak increases. Once the pulse has reached the certain pulse width that is sufficiently broad so that flank behavior is negligible, an additional pulse is introduced (see the third row). This added pulse is then pulse width-increased up to the certain pulse width. Thereafter, new pulses are introduced between the existing pulses until a maximum number of pulses has been reached. Lastly (row seven forward), the pulse width of all pulses is increased simultaneously up to maximum light.

An alternative way of achieving this would be to increase the pulse width until the certain pulse width and to thereafter decrease the period time of the repeated signal. As will be seen below, however, this is sometimes not a feasible solution in embodiments (such as for multi-channel LED drivers) where a fixed total time for a repeated signal pattern is desired.

FIG. 5 is another view showing an exemplary LED driver 100 having three channels, for instance for driving an RGB LED or LED strip 10. Three different dimming values (such as red, green blue) are received by the LED driver 100 and specifically by the microcontroller 130. The microcontroller 130 outputs one corresponding binary control signal to each of three analog drive circuits 140′, 140″, 140′″. The drive circuits 140′, 140″, 140′″ each produce a corresponding analog control signal, which is fed to a corresponding switch 180′, 180″, 180′″, each in turn having a driver output terminal 182′, 182″, 182′″ providing a respective varying (pulsed) voltage signal to each of three respective inputs on the LED load 10, the voltage signals providing the desired set dimming and color settings.

### First Aspect of the Invention

Turning now specifically to the first aspect, and with reference to FIG. 2 and FIG. 5, the LED driver 100 comprises the first-channel electric driver output 182′ to which the LED driver 100 is arranged to provide a current according to the first-channel binary control signal provided by the binary control signal generator 136.

The first-channel timer function 132′ can be configured to update a first-channel timer counter variable at a first-channel timer frequency, the first-channel timer function 132′ being configured to, for each such update, compare the first-channel timer counter variable to a set first-channel compare value, and the first-channel timer function 132′ being further configured to, in case the first-channel timer counter variable has reached or gone past the set first-channel compare value, cause the first-channel binary control signal to switch between a first binary state and a second, different, binary state. The corresponding can also be true for any second-channel or further-channel timer function 132.

In some embodiments, a clock frequency of the timer function 132 is at least 50 MHz, such as at least 100 MHz, such as at least 150 MHz. In some embodiments, the binary control signal is arranged to switch between a first binary state and a second binary state and back to the first binary state again at a frequency of at least 20 kHz, such as at least 25 kHz. Such switching can be an average switching frequency over time for at least some ingoing dimming values.

As described above, dimming smoothly down to complete darkness is difficult without a high-resolution duty cycle using conventional PWM. To make matters worse, calibration would be rather coarse, resulting in poor intra-channel matching.

In practice, the present inventors have used a microcontroller STM32G484, available from ST Microelectronics, as the microcontroller 130. This microcontroller comprises a CPU 131 capable of performing floating point calculations at a clock frequency of 170 MHz, and it also features Direct Memory Access (DMA) functionality, making it possible to copy data from one memory area to another without directly involving the CPU 131. The STM32G484 also features six “high resolution timers”, also known as “HRTIMers”, used as the respective timer function 132 for each of the supported channels. The HRTIMers are based on DLL technology and are capable of splitting each clock pulse into 32 parts. This provides a lowest time resolution of the microcontroller of

$$\frac{1}{( 32 \cdot 170 \cdot {10}^{6} )} \approx 184 ps .$$

The STM32G484 furthermore has two output channels per timer, making it (32.170.106) possible to construct an LED driver 10 having a total of twelve channels, using the principles described herein, and is based on 16 bits counters. If the PWM period time is set to 65535-32=65503, which is the longest possible period time using this counter, a PWM frequency of

$$\frac{32 \cdot 170 \cdot {10}^{6}}{65503} \approx 83 kHz$$

is achieved. Therefore, using one and the same compare value is not a possible way to generate a high-resolution but low-frequency binary control signal.

However, the compare value can be updated before each HRTIM period, as will be explained in the following.

If, for example, a 32 kHz PWM signal is desired, the required number of HR (High Resolution) clock cycles can first be calculated:

$$\frac{32 \cdot 170 \cdot {10}^{6}}{32000} = 170 0.$$

Since this value is higher than 65503, it is split in three:

$$\frac{170000}{3} \approx 56666.67 .$$

The period time is set to the lower nearest integer, in this case 56666, resulting in a total repeated control signal pattern period time of three periods of 56666, or a total of 169998 HR cycles and a PWM frequency of about 32000.38 Hz.

As an example, assume that the desired duty cycle for a corresponding PWM signal is 84.31393%. This then yields a total compare value of 169998-0.8431393=143332 HR cycles. It is noted that this is both more than 56666 and more than 56666-2=113332. Therefore, the two first compare values are each set to 56666, yielding an output control signal remaining at the high level for the two first run-throughs of the HRTIM period. The third compare value is set to the remaining value 143332-56666-2=30000.

In other words, at HR clock cycle 0, the compare value is set to 56666 and the counter variable starts from 0. The produced control signal is at the logical high value (such as being or corresponding to 3.3 V or “full light”). At HR clock cycle 56666, the counter variable reaches the end of the HRTIM period, and is reset to 0. The compare value is again set to 56666. The control signal remains at the high value. At HR clock cycle 113332, the counter variable is again reset to 0, and the compare value is set to 30000. The control signal remains at the high value. At HR clock cycle 143332, the counter variable reaches the compare value of 30000 and triggers a switch of the produced control from the high value to the logical low value (such as being or corresponding to 0 V or “no light”). The counter variable continues to increase until it reaches the end of the HRTIM period. Then, a switch of the output control signal is again triggered, now back to the high value, and the procedure restarts from the beginning using a counter variable reset to 0.

By updating the compare values after each HRTIM period, arbitrarily low frequencies can be generated while maintaining the required high time resolution. Again using the period time of the above example, a PWM frequency of 250 Hz can be generated by combining 128 times more the number of periods:

$$\frac{32 \cdot 170 \cdot {10}^{6}}{56666 \cdot 3 \cdot 128} \approx 250 Hz .$$

This means that 3-128=384 defined compare values can be used to generate a repeated binary control signal pattern that varies between 250 Hz and 32 kHz.

In general, a duration of the repeated control signal pattern of the binary control signal can be longer than the time it takes for the timer counter variable to complete a full cycle. This was illustrated in the example above, in which the counter variable reached the end of the HRTIM period several times before reaching the full length of the control signal pattern. Further generally, the repeated control signal pattern can comprise one or several pulses.

The LED driver 100 can be arranged to update the set compare value at least two times, or even, as seen in the example above, at least three times, or even more than three times, during each individual control signal pattern.

The timer function 132 can in principle have a clock frequency that is independent of a used clock frequency of the CPU 131 of the microcontroller 130. However, in some embodiments the CPU 131 can be arranged to run at a predetermined clock frequency and a clock frequency of the timer function 132′ (the timer frequency) can be at least as high as, or higher than, the predetermined clock frequency of the CPU 131.

As mentioned in the example above, the timer function 132 can use the DLL 133, that in turn may be configured to divide a timer function 132 clock (a timer input clock period, “input” referring to the fact that the clock enters into the timer peripheral) into several fractional steps. This is equivalent to increasing the timer resolution of timer function 132 but without the need to increase the clock frequency of the same.

As also mentioned in the example above, the timer function 132 can be cyclic, meaning that the counter variable restarts from an initial value repeatedly, in the example above after the end of each HRTIM period has been reached, and is compared to the current compare value when stepping through the timer function 132 period. Herein, the terms “HRTIM period” and “timer period” are used interchangeably, but it is understood that the more general term “timer period” is equally applicable as “HRTIM period”. In the concrete example discussed herein, the HRTIM timer divides the clock cycles using DLL, but in the more general case other concrete mechanisms can be used to define a suitable timer period.

As described, the exemplary HRTIM period of 56666 clock cycles means that the compare value needs to be changed after this time has passed, meaning in the example above 96000 times per second. If this task were for the CPU 131 to perform, it would need to devote a large share of its capacity to this task. Instead, the present inventors propose to perform the compare value update in the background, such as using a DMA channel.

Namely, in the above example the HRTIM units are controlled by a master clock that is reset after 56666 HR clock cycles. Each time it resets, all currently used compare values (for each channel) are consumed, and new ones are needed. A DMA channel is configured so that each time new values are needed they are read directly from a circular RAM buffer, provided as or in the RAM area 134 and holding 384 values for each channel. Since the buffer is circular, the fetching of values is restarted from the beginning after all 384 values have been copied, and if the incoming dimming value has not changed the contents of the RAM buffer also needs not change. This offloads the updating work from the CPU 131. Once the dimming value is updated, a different algorithm is configured to update, if needed, data in the RAM buffer. In this example, this needs then be done at most every time the RAM buffer has been reached, namely 250 times per second. This updating can then be performed by the CPU 131 at substantially lower computational cost. The longest repeated control signal pattern possible without changing the values in the RAM buffer is then defined in terms of the number of clock cycles in each HRTIM period times the number of compare values that fit in the RAM buffer. In various embodiments, the RAM buffer can be dimensioned to hold at least 2, such as at least 4, such as at least 8, at least 16 or even at least 32 compare values at any given time. It is realized that the compare values can generally be integers.

Hence, the compare values in the RAM buffer can be configured to together define the repeated control signal pattern, in turn forming the binary control signal as the control signal pattern is repeated. As the dimmer setting is changed, the RAM buffer needs to be updated with a correspondingly updated set of compare values that together define a new repeated control signal pattern reflecting the updated dimmer setting. To this end, the CPU 131 can be configured to, in reaction to an updated dimmer setting received by the LED driver 100, update the RAM area 134 with an updated set of compare values specifically selected to reflect the updated dimmer setting.

Generally, the compare value copying function 135 can be configured to update the timer function 132 with an updated set compare value from the RAM area 134, such as one such compare value for each channel supported by the LED driver 100.

For microcontroller units in general, there are a number of different ways for a non-CPU component, or peripheral component, of the microcontroller in question, such as the timer function 132, to receive and process updated information. As a first example, using a polling interface the updated value is fed to the component by the CPU, and the CPU waits for the value to be consumed before feeding the next value. This is not a very efficient way to use CPU resources since the CPU will then be locked during the time it takes for the component to consume the value. As a second example, an interrupt-controlled interface can be used. Then, a value or a buffer is fed to the component, whereupon the component consumes the values in the background. Once the values are fully consumed, an interrupt is generated that can be caught by the CPU and used to trigger a buffer data update. As a third example, a DMA controlled interface can be used. Then, the component is connected to the RAM area 134 and a DMA channel is configured to perform the specific use of the data that is specific to the application. Once the component requires a next value it signals this to the DMA channel, which in turn is responsible for providing the next value to the component. The value is copied by the DMA channel from the RAM buffer, and an interrupt can be configured to be generated automatically at a certain point, such as when the RAM buffer has been read fully or halfway through. For instance, a first interrupt can be triggered after a first share (such as half) of the RAM buffer compare values have been consumed, indicating that the first share can be updated, and a second interrupt can be triggered after a second share (such as the other half) of the RAM buffer compare values have been consumed, indicating that the second share can be updated, and so forth. This interrupt can then be caught by the CPU 131 and acted upon accordingly, such as by updating the values in the RAM buffer. As the CPU 131 knows where in the read cycle the process currently is, it can update the RAM buffer values that are currently not read.

In exemplary embodiments of the present invention, the second or third examples can be used for consumption and/or updating of the RAM buffer in the RAM area 134. Hence, the compare value copying function 135 can be or comprise a DMA channel, that can be a circular or cyclic DMA channel such that after it has reached the end of the RAM area 134 it continues copying from a beginning of the RAM area 134 again. The DMA channel can be arranged to notify the CPU 131, such as using an interrupt, when a certain point, such as half or full consumption of the values, has been reached, providing information to the CPU 131 about the current read state of the RAM area 134 so that the CPU 131 can act accordingly and update different parts of the RAM area 134 accordingly.

Alternatively, the compare value copying function 135 can be or comprise an ISR (Interrupt Service Routine) being executed in response to an IRQ, Interrupt Request, the ISR being arranged to signal, via an interrupt, to the CPU 131 that a new compare value is needed from the RAM buffer. When the IRQ signal is emitted, the CPU 131 executes the ISR, which is arranged to update the timer function 132 with a new compare value from the RAM buffer. Hence, the compare value copying function 135 can be configured to react to an interrupt produced by the IRQ in connection or reaction to the timer counter value reaching its full cycle value, the reaction then comprising copying a new compare value from a next or subsequent memory position of the RAM area 134. Further alternatively, an IRQ can be used to alert, via an interrupt, the CPU 131 that the RAM buffer has been fully consumed and that it is time for the CPU to update the RAM buffer compare values.

As is illustrated by the above example, the repeated control signal pattern can be defined to be longer than the HRTIM period, in other words the time it takes for the timer counter variable to complete a full cycle. Moreover, one or several individual pulses forming part of the repeated control signal pattern can be longer than the HRTIM period, meaning that at least one compare value will be equal to or more than the number of HR clock cycles in one HRTIM period. This way, the repeated control signal pattern is in a sense independent of the HRTIM period, since both individual pulses and the entire control signal pattern can extend in time beyond the boundaries of a single HRTIM period.

In the following, the mechanisms for defining the repeated control signal will be explained and exemplified in closer detail. In general, the LED driver 100 can be arranged to vary at least one, such as both, of firstly, a number of pulses provided across the repeated control signal pattern, and secondly, a respective pulse width of one or several of a set of one or several pulses provided across the repeated control signal pattern, in way so that different desired time-averaged currents (or voltages) can be provided to the driver output 182.

As will be seen from the below, the LED driver 100 can generally be arranged to gradually increase the time-averaged applied voltage or current to the driver output 182, as the dimming value is gradually increased from a low level to a high level, by first increasing a pulse width of one or several pulses provided across the repeated control signal pattern and to thereafter, to further increase the light intensity, increase a number of pulses provided across the repeated control signal pattern. As we will see, this can then be repeated by growing a respective pulse width of one or several such added pulses, thereafter adding one or several additional pulses, and so forth.

Continuing on the example discussed above, a “pulse period”, in the PWM sense, can be defined to be a concatenation of three compare values, so that 128 individual such PWM pulse periods are used together to define the repeated control signal pattern and hence the instantaneous shape of the binary control signal. It is realized that the repeated control signal pattern can have any arbitrary shape, for instance so that individual pulses are distributed in a less regular manner than forming trains of such “PWM pulses”, but for the present example this is the case. It is particularly noted that one or several parts of the general methodology described regarding how individual pulses are introduced and grown can be applied for other pulse patterns across the repeated control signal pattern. When a particular part of a pulse pattern can be analyzed in terms of a PWM pulse, it is herein denoted “PWM like”. It is realized that this terminology is used to facilitate understanding of the invention, and is not intended to limit the described embodiments to PWM in its conventional meaning (having a single repeated pulse the duty cycle of which is varied over time).

Using such three-compare-value PWM pulse periods, a threshold pulse width (the threshold width being defined as a width reached before a new pulse is introduced) is set to a value under 169998, such as 10000. For the lowest light powers, only one PWM pulse will be non-zero across the repeated control signal pattern, but as the dimming value is increased the pulse width of this single PWM pulse will be increased until it reaches the threshold pulse width in question. At this point, a second PWM pulse is introduced and starts to grow with increasing dimming values. Once the second PWM pulse has reached the threshold pulse width, a third pulse is introduced and starts to grow, and so forth. When all 128 pulses have reached the threshold pulse width, the compare values are adjusted so that the respective pulse widths of all PWM pulses are widened simultaneously. It is noted that the compare values can be set so that all PWM pulses are treated in the identical same manner as described, but alternatively so that different PWM pulses have slightly different properties, such as being associated with different threshold pulse widths before the next pulse is introduced or where in the repeated control signal pattern the pulse in question is placed. This provides a way to tailor the pulse-defining algorithm to achieve very precise dimming even for hardware platforms with various hardware constraints, such as a minimum or maximum number of clock cycles for the compare value and similar. If the pulse widths are controlled individually, degradation of bit resolution can be avoided and as a result the effective number of bits for the control signal can be caused to be constant and given as an expression of the total number of clock cycles in the repeated control signal pattern, which in this example results in:

$$nBits = \frac{log ( 128 \cdot 3 \cdot 56666 )}{log ( 2 )} \approx 24.3 \; 75 bits .$$

The time spent in the high level (instead of the low level), in relation to the total time of the repeated control signal pattern defines a sort of PWM-like “duty cycle”.

Generally speaking, the LED driver 100 can be arranged to distribute the at least one pulse of the repeated control signal pattern across the repeated control signal pattern over a set of predetermined and/or evenly distributed, or substantially evenly distributed (such as to a precision allowed by the distribution mechanism), time pulse positions across the repeated control signal pattern. In some embodiments, this distribution can take place according to a bit-reversal of a binary representation of a number, the number in turn describing or corresponding to the index of the pulse within the first-channel control signal pattern. This will now be exemplified.

Hence, let {P_{I}_{₀}, P_{I}_{₁}, P_{I}_{₂}, . . . , P_{I}_{₁₂₇}} be the determined (desired) pulse widths of the 128 individual PWM pulses comprised in the repeated control signal pattern, where Iₖ ∈ [0,127]. Furthermore, let M be the threshold pulse width before an additional PWM pulse is introduced. Before the highest frequency is reached, this results in a sequence according to {M, M, . . . , M, x, 0, 0, . . . , 0}, where x ∈ [0, M) and N is the number of PWM pulses having a pulse width of M. If T is the total HR clock cycle length T=56666·3·128=21759744 of the three-compare-value PWM pulse periods and the desired average PWM-like duty cycle (instantaneous intensity I), the sequence will fulfill the equation M·N+x=T·I.

Now the mapping Iₖ can be determined. If Iₖ=k, all pulses would fall after each other followed by a long break, resulting in a large 250 Hz component, in turn risking the result of flickering and disturbing sounds. To solve this, the mapping Iₖ can be designed to maximize the resulting PWM frequency. One way to achieve this is to represent k as a binary number, such as a 7-bit number, and then reverse or swap the bits and use the mapping Iₖ=k_{swap}. For the first values, the following is achieved:

| k | 0 | 1 | 2 | 3 | 4 | 5 |
|---|---|---|---|---|---|---|
| k_{bin} | 0000000 | 0000001 | 0000010 | 0000011 | 0000100 | 0000101 |
| k_{swap} | 0000000 | 1000000 | 0100000 | 1100000 | 0010000 | 1010000 |
| k_{swap} (dec) | 0 | 64 | 32 | 96 | 16 | 80 |

| k | 6 | 7 | 8 | 9 | 10 |
|---|---|---|---|---|---|
| k_{bin} | 0000110 | 0000111 | 0001000 | 0001001 | 0001010 |
| k_{swap} | 0110000 | 1110000 | 0001000 | 1001000 | 0101000 |
| k_{swap} (dec) | 48 | 112 | 8 | 72 | 40 |

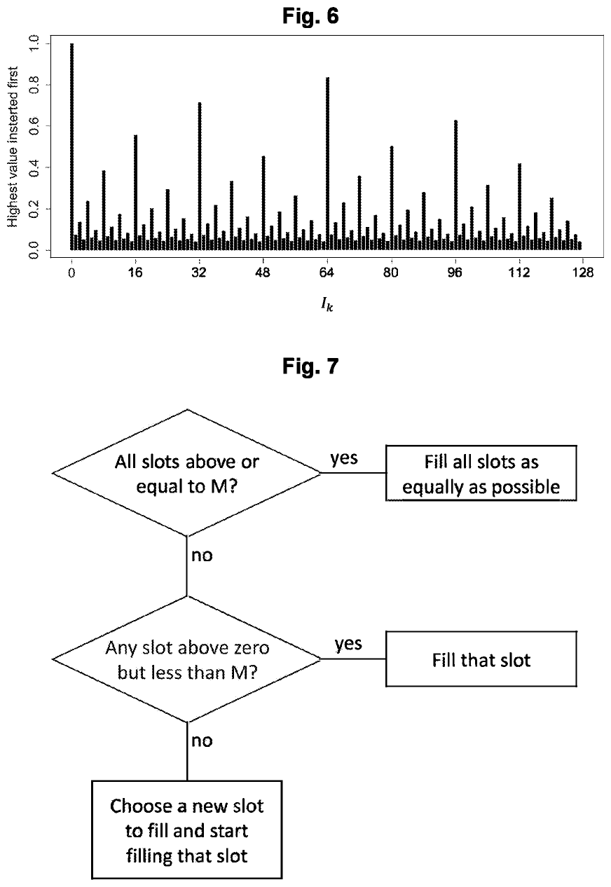

This is visually illustrated in FIG. 6, in the form of a graph wherein the height of each bar symbolizes the order in which the corresponding PWM pulse is introduced, higher bars being introduced earlier (the first bar is introduced for k=0). This way of introducing pulses across the repeated control signal pattern guarantees that the pulses are as spread-out as possible while not drawing too much compute resources. It is realized that this distribution mechanism can be used also for less regular pulse distributions, so that the introduction of pulses is distributed using bit binary swapping or a similar mapping mechanism even if the pulses themselves are not perfectly evenly distributed across the repeated control signal pattern.

Hence, for the binary system, where numbers are represented in a series of 0s and 1s, the bit reversal process is as described above. However, this concept of reversal isn't confined to the binary realm. It extends to more complex systems. In a more general case, for instance, a mixed-radix base of primes is used. Unlike the binary system, wherein each digit has a base of 2, mixed radix systems involve numbers with different bases at different positions. In a mixed-radix base of primes, the primes are sorted from a highest to a lowest number (the lowest prime is the least significant position). Then the order is reversed to be lowest-to-highest (highest prime is least significant position). Then, given a starting frequency, say 250 Hz, the higher end of the interval (which is 32 kHz in the example above) can instead be selected arbitrarily, to be for instance 24 kHz. Furthermore, if the ratio between the highest frequency and lowest frequency would not be a power of 2, a mixed radix base could instead be used. This could then potentially result in an even better dimming performance. As a specific example, assume the ratio is 24000/250=96=3 2⁵. Since 96 can be factored as 3·2⁵, a mixed radix base having bases {3, 2, 2, 2, 2}can be used to represent the number. The bases are ordered from highest to lowest such that the lowest base has the least significant value. The representation becomes {s5,s4,s3,s2,s1,s0}. Now, if a number is expressed in this base, the possible values ranges from 0 to 95 and are described by a sequence (s5,s4,s3,s2,s1,s0). Then, the representation is reversed to {s0,s1,s2,s3,s4,s5} and is observed using the mixed radix base {2, 2, 2, 2, 3}. Hence, the process of “bit-reversal” described above is here generalized to “digit-reversal” and then consists of reversing the sequence into (s0,s1,s2,s3,s4,s5) and computing the new index using the base (2, 2, 2, 2, 2, 3), where the base is now ordered from lowest to highest. Based thereupon, the index is calculated, whereby the sequence (0, 1, 2, 3, . . . ) would be mapped to (0, 48, 24, 72, 12, 60, 36, 84, 6, . . . . )

In this and in other embodiments, a duration of the repeated control signal pattern can be constant across different desired time-averaged currents provided to the driver output 182. In other words, in some embodiments the duration does not change with the dimming value but instead the concentration of high-value clock cycles across the control signal pattern is instead changed by altering the pulse pattern.

As another alternative, it would be possible to allow, by way of example, a 250 Hz pulse signal to grow, as the dimming value increases, in pulse width until a certain threshold pulse width was reached. Thereafter, as the dimming value increases further, the period time could be decreased continuously to introduce the pulses more and more often over time. Once the frequency reaches a certain maximum value, such as 32 kHz, the pulse width can again be increased until 100% duty cycle is achieved. This type of modulation works particularly well with single-channel LED drivers 100 and can also be achieved using the multi-HTRIM-period pulse structures generally described above.

However, for a multi-channel LED driver 100, the fact that the duration of the respective repeated control signal pattern is not the same for different channels means that there will be a drift in terms of instantaneous current requirements across the different channels. To clarify the consequences of this, one can assume two channels with PWM duty cycles D₁>0 and D₂>0, D₁ #D₂, meaning in the latter example that the corresponding PWM frequencies ƒ₁ and ƒ₂ are not equal, ƒ₁≠ƒ₂. When the respective channel is leading (high value for the binary control signal), an increased current requirement arises, in turn causing the voltage on the DC bus 121 to decrease temporarily. The size of this sinking depends, inter alia, on the size of the LED load 10 and the amount of capacitance on the DC bus 121. This means that, if the channels are active at the same time, a certain current requirement will arise, but if they are active at different times a different current requirement will arise. Interference will then arise on sums and differences of the respective frequencies, meaning that the frequency f₁−f₂ will have a non-zero amplitude. If, for example, f₁≈f₂, a low-frequency flickering may occur, which is not desirable. Hence, using f₁=f₂ configurations, for instance according to the above example, is often more suitable for multi-channel LED drivers 100 than f₁≈f₂ configurations.

Generally, the relative current requirement across different channels can be arranged to be stable, and not drift. To this end, one respective periodic signal (such as the repeated control channel pattern) can be generated on each channel, where the periodicity is the same for all channels, and where the periodicity can be as long as the longest PWM period of PWM pulses together forming the periodic signal. In other words, the signal can be constructed from a sequence that is repeated, and the sequence is generated as a concatenation of individual PWM-like pulses. Since the sequence is periodic, the voltage on the DC bus 121 will also be periodic with the same period, resulting in a constant light contribution from a pulse so long as it is not moved in the sequence. If a pulse is moved to a different position, there is a risk that a notch results in the dimming curve. Once a pulse has been introduced at a certain point in the sequence as the dimming value is increased, the LED driver 100 can be configured to keep that introduced pulse in that location in the sequence as long as the dimming value is increased.

Generally, the LED driver 100 can comprise, in addition to the first-channel electric driver output 182′, a second-channel electric driver output 182″ and any third-channel 182′″ or further electric driver output. Like for the first-channel electric driver output 182′, the LED driver 100 can be arranged to provide a current to the second-channel driver output 182″ and any further driver output 182′″, etc., according to a corresponding binary control signal, such as a second-channel binary control signal. The LED driver 100 can also correspondingly comprise a second-channel timer function 132″ and any third-channel 132′″ or further timer function, being configured to update a corresponding second, third or further-channel timer counter variable at a second, third or further-channel timer frequency. The second 132″, third 132′″ or further-channel timer function can be configured to, for each update, compare the second, third or further-channel timer counter variable to a set second, third or further-channel compare value. The second 132″, third 132′″ or further-channel timer function can be configured to, in case the timer counter variable in question has reached or gone past the set compare value in question, cause the binary control signal in question to switch between a corresponding set of binary states, such as for the second-channel binary control signal between a third binary state and a fourth, different binary state. This functionality can hence correspond to what has been generally described above in relation to the binary control signal and specifically to the first-channel binary control signal.

Then, a duration of a repeated second, third and/or further-channel control signal pattern of the second, third and/or further-channel binary control signal can be longer than the time it takes for the second, third and/or further-channel timer counter variable to complete a full cycle. As is the case for the first-channel control signal pattern, the second, third or further-channel control signal pattern can each comprise one or several pulses.

Moreover, the LED driver 100 can then be arranged to update the set second, third and/or further-channel compare value at least two times during each individual second, third and/or further-channel control signal pattern, respectively.

In such cases, a duration of the first-channel control signal pattern can be an integer multiple of, such as the same as, a duration of the second, third and/or further-channel control signal pattern. This will result in no intra-channel drift. It is noted that the same effect is achieved if the first-channel control signal pattern is an even fraction of a duration of the second, third and/or further-channel control signal pattern, in case the duration of the first-channel control signal pattern is the shorter duration.

To achieve as stable DC voltage as possible, it is desired for the LED driver 100 to draw as smooth a current as possible. If it is assumed that the corresponding PWM duty cycle is, for instance, 10% across all channels, and that the activated binary control signal sequence activates all channels at the same time in the sequence, the current requirement would be unnecessarily high, followed by an unnecessarily long pause before the next current requirement would arise.

If instead an offset is introduced on the channel level, the offset being different for each channel, the current requirement would not arise simultaneously on each channel, in turn resulting in a smoother overall current requirement. As the frequency contents in the current requirement increases, the capacitance on the LED driver 100 does not need to supply the circuitry with current during as long a time, yielding a lower capacitance requirement and by consequence lower manufacturing costs.

Generally, the first-channel binary control signal can be time-offset in relation to the second, third and/or further-channel binary control signal by a respective offset value that is smaller than the first-channel control signal pattern duration.

For LED drivers 100 having three or more electric driver outputs 182′, 182″, 182′″, each of the respective binary control signals for the different channels can be offset by a value lower than the duration of the first-channel control signal pattern, and the respective time-offsets of the at least three control signal patterns can be distributed over a set of predetermined and distributed time offsets across the first-channel control signal pattern. The distribution of the at least three control signal patterns can be even, or substantially even (given available granularity on the hardware used, for instance), across the repeated control signal pattern duration.

For instance, bit reversal similar or corresponding to the above-described manner of distributing pulses across the repeated control signal pattern can be used to distribute the offsets for the respective binary control signal of different channels. If Mᵢ is the offset for channel i, the offset values M={0, 64, 32, 96, 16, 80, 48, 112, 8, 72, 40, 104} for a twelve-channel LED driver 100. This yields a distribution across the channels that generally provides a smooth current requirement and therefore smoother voltage and lower capacitance requirements. For multi-channel LED strips, this yields even less flickering, since the instantaneous light intensity decreases at the same time as the frequency increases.

In general, the distribution of offsets across different channels can take place according to a bit-reversal of a binary representation of a number, the number in turn describing or corresponding to a channel index of electric driver outputs 182′, 182″, 182′″. The distribution can be across the first-channel control signal pattern duration used.

The following is an illustration of a procedure of the type generally described above, designed to use a variadic frequency for driving a constant voltage LED load 10 and to avoid stutter, flicker and interference patterns.

N is the maximum number of pulses in a periodic signal (the repeated control signal pattern). All pulses have one and the same threshold pulse width Wₘₐₓ measured in clock cycles, equal to one Nth of the total number of clock cycles in the periodic signal, Tₜₒₜₐₗ.

W[0], W[1], . . . , W[N−1] are the N slots that hold the counter values for each respective pulse width.

The desired intensity I_{avg} is a value in the range [0, 1].

The task at hand is now to fill all slots such that

$${I}_{a v g} = \frac{1}{N \cdot {W}_{max}} ( {\sum }_{i = 0}^{N - 1} W [ i ] ) .$$

The slots can be filled using the flow diagram shown in FIG. 7.

Left to do now is to decide in which order new slots should be chosen. If W[0] would be filled first, followed by W[1], W[2] and so on, a large low-frequency component would be present in the signal. To minimise flicker as much as possible, after the first slot has been filled, the next slot to be filled should be at the furthest distance from the first slot. This will ensure that low-frequency content of the signal is always minimized. So, if the first slot that was filled was W[0], then the next one should be W[N/2]. After that it would proceed in a binary fashion, inserting new pulses at the furthest distance away from the existing pulses. If N can be written as, N=2^{m} for some integer m, this type of indexing can be computed by doing an m-bit reversal of a linearly increasing index i.

Given the constraints of the microcontroller that was used in the setup used by the inventor, the high-resolution timer was limited to 16 bits. This is hence merely an example. With a highest equivalent clock frequency of 32-170 MHz=5.44 GHz, the lowest possible PWM frequency is then achieved when the timer period is at its maximum value, being equal to 65535-96=65439. Dividing the equivalent clock frequency by this number, one gets about 83 kHz, which is too high for the task at hand. By letting each slot W[i] consist of three counter periods of 56666 clock cycles each, the maximum frequency is instead

$$\frac{5.44 e 9}{3 \cdot 56666} = 32 kHz .$$

By letting N=128, 3.56666 the lowest frequency is then 250 Hz.

For any other set of minimum and maximum frequencies, the following procedure can be used:
Given is the clock frequency f_{TIM} of a timer peripheral, for example ƒ_{TIM}=170 MHz·32=5.44 GHz
Define a ratio N between the highest and lowest PWM frequency N=ƒₘₐₓ/fₘᵢₙ, for example N=128.
Define a target frequency f_{minTarget} of the lowest frequency content of the signal, for example ƒ_{minTarget}=250 Hz.
In the formula Tₐₚₚᵣₒₓ=ƒ_{TIM}/(fₘₐₓ·b), find the lowest integer b such that the result is below the maximum counter value. This gives both Tₐₚₚᵣₒₓ and b, for example

$${T}_{approx} = \frac{{f}_{TIM}}{{f}_{max} \cdot b} = \frac{5.44 e 9}{32000 \cdot 3} \approx 56666.6 \; 67 and b = 3.$$

Truncate Tₐₚₚᵣₒₓ to an integer, for example T=56666.
The example values gives

ƒₘₐₓ=ƒ_{HRTIM}/(b·T)=5.44e9/(3·56666)≈32000.376475 Hzfₘᵢₙ=ƒₘₐₓ/N≈250.002941 Hz.

N defines the number of different pulse widths that are to be generated before the sequence starts over. Each pulse has a maximum length of b·T clock cycles, for example 3 56666=169998 clock pulses. Define W[i] to be the pulse width of pulse i, where i is an index ranging from 0 to N−1. The total on-time is W[0]+W[1]+ . . . +W[N−1] and the total time is T·b·N clock cycles, for example 56666·3·128=21759744. If the controller input signal is equal to the average light intensity to be generated with range [0,1], the quantity can be defined as

$${I}_{a v g} = \frac{< total on - time >}{< total time >} = \frac{W [ 0 ] + W [ 1 ] + … + W [ N - 1 ]}{T \cdot b \cdot N} .$$

If all W[i] would be the same value, the control signal being generated would be a pure PWM signal with frequency fₘₐₓ and the duty cycle would be D=I_{avg}=W[i]/(b·T). If all W[i]-values were zero except for one index i, the control signal being generated would be a pure PWM signal with frequency fₘᵢₙ and with duty cycle D=I_{avg}=W[i]/(N·b·T). In the general case, the frequency content of the signal is mixed, dependent on which bins are filled. However, the number of pulses per second is ƒₘᵢₙ·<number of nonzero W[i]> and the minimum frequency component of the signal being generated will not be lower than ƒₘᵢₙ.

The algorithm can be summarized as follows:
Configure a timer peripheral such that a periodic signal of N pulses can be generated with the desired ƒₘᵢₙ and ƒₘₐₓ N is selected such that N=2^{m}, for some m.
Decide a minimum pulse width M that is going to be used. The lower the value, the faster the frequency will go from ƒₘᵢₙ to ƒₘₐₓ when increasing intensity.
Define n to be the number of slots that can be filled at least with the pulse width M. n is computed by

$$n = \frac{{T}_{t o t a l} \cdot {I}_{a v g}}{M}$$

and then truncated to its integer part.
Define an array that is to be filled up sequentially, Z[0],Z[1], . . . ,Z[N−1].
If n<N, fill up the first n slots in Z with the value M and set the next slot to the residual, Z[n]=Tₜₒₜₐₗ·I_{avg}−n·M. All other slots are set to zero.
Otherwise if n≥N, fill all slots as equally as possible: First, set all values to Z[i]=Tₜₒₜₐₗ·I_{avg}/N, where all values are truncated to their integer parts. Then compute the residual R=Tₜₒₜₐₗ·I_{avg}−Z[0] ·N. This is a value in the range [0, N−1]. Increase the first R slots with one to minimise the residual.
Scramble the indices by setting W[rev(i)]=Z[i], where rev is the m-bit reversal function.

### Second Aspect of the Invention

Turning now instead specifically to the second aspect of the present invention, it has been understood from the above that the binary control signal is, or is an analog representation of, a digital control signal in turn used to switch the LED load 10 on and off. However, the drive circuitry 140, the drive switch 180 and the LED load 10 itself all have dynamic electrical properties that will alter the resulting signal actually delivered to the LED load 10. If, for instance, a PWM signal with duty cycle D is used as the control signal based on which the LED load 10 is driven, the actual average current through the LED load 10 will differ from iₘₐₓ times D, where iₘₐₓ is the current through the LED load 10 when D=1.

As an example, in case the raw or compensated binary control signal is provided to a MOSFET (Metal-Oxide-Semiconductor Field-Effect Transistor) that in turn is used to output the drive current to the LED load 10, the relationship between the gate voltage V_{gs} and its internal resistance R_{ds} is complex and depends on several factors. When the drive circuitry 140 takes a non-zero time t>0 to charge V_{gs} this complex relationship will give rise to a deterministic (but normally unknown) change of R_{ds} during the charge and decharge process. As the time t becomes so long that a visible amount of light is emitted before the charging is completed, this will result in such light being emitted before the current through the LED load 10 has reached its maximum. Again, how much such light is emitted is determined by a complex and normally unknown relationship that is determined both by the transistor itself and also the drive circuitry 140. It is noted that the drive circuitry 140 can be as described below in connection to the third aspect, but that any drive circuitry 140, such as using a simple series-connected resistor, will give rise to complex dynamic behavior to some degree. For example, a resistor will be associated with a certain precision and manufacturing variability, so that every resistor of the same type does not have the exact same properties. Even if resistors with higher quality are selected, any transistors used in the drive circuitry 140 will have dynamic properties, and so forth.

The amount of light emitted from a light source, such as an LED, is directly proportional to the current. Hence, if the current is integrated over time, a measurement of the total amount of emitted light can be achieved. The intensity of the light can be defined as

$$I = \frac{{\int }_{0}^{T} i ( t ) d t}{{i}_{max} T} ,$$

Where T is the period time for the signal (the period of the repeated control signal pattern), i(t) is the varying current through the LED load 10 and iₘₐₓ is the current reached at 100% duty cycle (binary control signal at constant high value).

Now, the duty cycle D can be defined as the amount of time that the currently used repeated control signal pattern is in the high value divided by the period of the currently used repeated control signal pattern. In the ideal case, I=D. However, due to the above-described complex relationship this equation will not hold. But the relationship between I and D can be measured, such as by connecting a typical LED load 10 or another electric load to the LED driver 100 and then measure I(D).

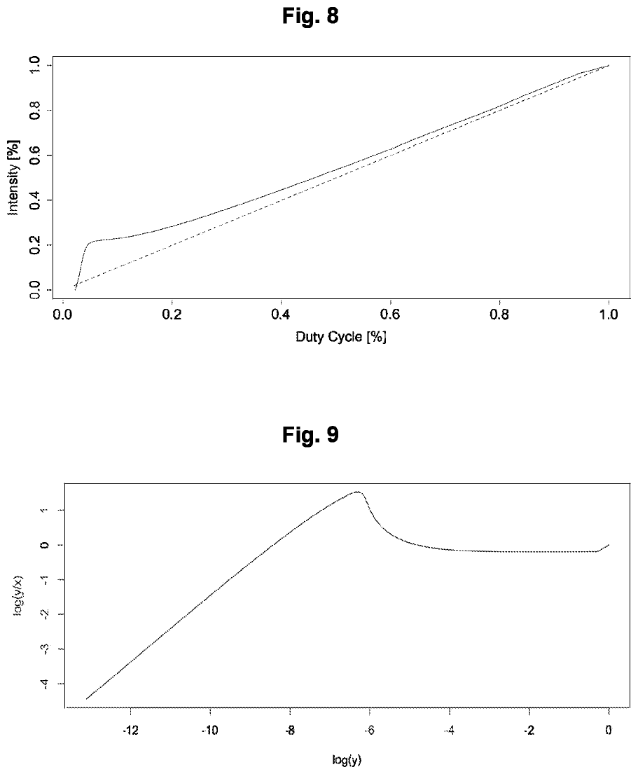

In the following, an example will be presented to illustrate this. Since the frequency change on the output signal of the LED driver 100 typically adds extra complexity, the frequency was first fixed to 250 Hz for all intensities. I(D) was then measured and the results are presented in FIG. 8. The dotted line is I=D.

The present inventors propose to find the inverse of the measured function I(D), that is D(I), and then to use D(I) to find a certain duty cycle of the binary control signal to use, given a desired light intensity.

To better understand how each PWM-like pulse is altered by the LED driver 100, let H be the system consisting of the drive circuitry 140, drive switch 180, and a typical LED load 10. Furthermore, let s be a binary control signal going into this system and let x be any single PWM-like pulse in s. Let y=H(x, e) be the equation that describes how x gets modified by the system H. In the equation, x and y are pulse widths measured in seconds, where y can be computed by taking the time integral of the pulse and dividing with its maximum value (yielding an effective pulse width for a constant maximum-value pulse). e is any set of external variables that may affect the system, which could be ambient temperature, average value of s, maximum current iₘₐₓ, drive supply voltage, etc. Depending on the scope of H, x and y could represent pulses of voltages and/or currents.

FIG. 4d illustrates a non-square pulse further illustrating the concept of “effective pulse width” in the present sense. It is a typical waveform of a pulsed current through an LED load. Since the amount of light is proportional to the current, the time integral of the waveform measures the amount of light emitted from one single pulse. If this time integral is set to be equal the time integral of an ideal rectangular pulse with maximum current Imax, the rectangular pulse will represent the same amount of light and an effective pulse width. Hence, in FIG. 4d, showing a pulse, Imax is a maximum (current) level of the pulse, typically occurring on an upper plateau of the pulse. i(t) is the level (the current in this case) as a function of time. W_{eff} is the effective pulse width of the pulse. It is realized that

$${W}_{eff} = \frac{1}{{I}_{max}} {\int }_{t = 0}^{T} i ( t ) dt .$$

The relative intensity I can then be computed as W_{eff} divided by the period time T and then yields a value between 0 and 1.

For systems considered in this analysis, H(x, e) will be a continuous function that have a strictly positive and continuous derivative for all values x that are large enough to produce an output signal y>0. Thus, by the inverse function theorem, an inverse function x=H⁻¹(y, e) exists. If y is the wanted pulse with, x can be computed if H⁻¹ is known, and if x is fed to H, it will produce y. Thus, H⁻¹ together with H will produce the identity function, H(H⁻¹(y, e), e)=y.

By measuring y for different values of x over the whole spectrum of relevant pulse widths, data points (xᵢ, yᵢ) can be gathered for any set of external variables e.

A parametric model M can now be found such that M(y, e, v_{M})≈H⁻¹(y, e), where v_{M} is the set of internal variables for M. For an ideal system, the incoming and outgoing PWM-like pulse widths would be the same, H_{ideal}⁻¹(y)=y, so it may make more sense to analyze the discrepancy from the ideal:

$$M ( y , e , {v}_{M} ) = \frac{{H}_{ideal}^{- 1} ( y )}{G ( y , e , {v}_{M} )} = \frac{y}{G ( y , e , {v}_{G} )} ,$$

where G is another parametric model to be found. As the human eye has higher sensitivity at lower light levels, the model error should be smaller for lower intensities. Also, for low intensities, the PWM-like pulse widths are shorter and the dynamics of H will have a larger impact on D. Thus, it may be reasonable to expand the input values y in order to get more details for small values of y. This can be done by applying a non-linear function to y, such as log, pow or sqrt. In the following example, the logarithm of the intensity was used:

G(y,e,v_{G})=F(log(y),e,v_{F}),

where F is another parametric model.

As drive circuitry 140 and drive switch 180 behavior usually contains exponential relationships, the curve fitting can be simplified by removing this behavior by taking the logarithm of both sides and finding a model for the residual shape:

log(G(y,e,v_{G}))=log(F(log(y),e,v_{F}))=R(log(y),e,v_{R}),
where R is another parametric model.

Putting this together with the gathered data (xᵢ, yᵢ), one gets

xᵢ≈H_{ideal}⁻¹(yᵢ)/F(log(yᵢ),e,v_{F})=yᵢ/exp(R(log(yᵢ),e,vR))=>

R(log(yᵢ),e,v_{R})≈log(yᵢ/xᵢ),

and after finding R, the parametric model M can be computed by

M(y,e,v_{M})=y·exp(−R(log(y),e,v)).

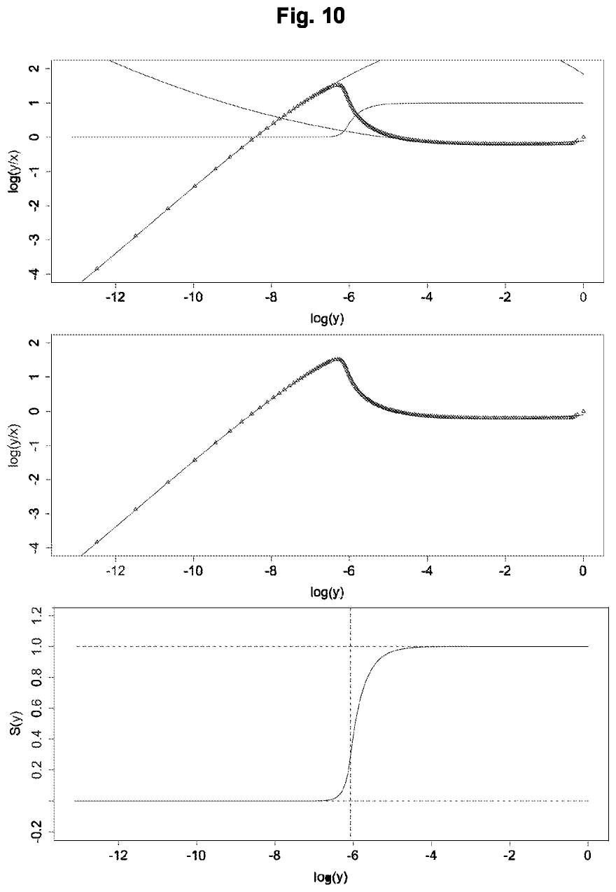

Left then, is to find the parametric model R using the relationship R(log(yᵢ), e, v_{R})≈log(yᵢ/xᵢ). This relationship is plotted in FIG. 9 for the present measurement example.

There are several ways to model R given the input variable log(y) and both parametric and non-parametric approaches can be used. For example, spline interpolation, polynomial approximation, lookup tables, kernel functions and parametric models can all be used with their respective pros and cons. One possible approach is to model R as two different low-degree polynomials, one such polynomial to the left and one such polynomial to the right of the maximum value of R. These two polynomials can then be fused together, for instance using a sigmoid function.

This principle is illustrated in FIG. 10, wherein, the black triangles are measured data. The full-line curves not following the black triangles in the top graph are the two polynomials and the sigmoid function. The sigmoid function itself is shown in the bottom graph. The full-line curve following the black triangles is the resulting model R.

The polynomials matching the curve to the left and right of its maximum have degrees 3 and 2 respectively. The sigmoid function S(x) consists of two exponential functions that are connected by letting S(x) and S′(x) be continuous at a centerpoint x_{c}:

S(x)=ƒ₁(x) if (x<xc),f₂(x) otherwise, where

ƒ₁(x)=exp(k₁(x−a₁)) and

ƒ₂(x)=1−exp(−k₂(x−a₂)).

Continuity of S(x) and S′(x) at x=x, give the parameters a₁ and a₂:

a₂=x_{c}+log(k₁/(k₁+k₂))/k₂

a₁=x_{c}−log(1−exp(−k₂(x_{c}−a₂)))/k₁.

This gives an asymmetric sigmoid function when k₁≠k₂.

Given the two polynomials and the sigmoid function, a total of 10 parameters are then needed to approximate H⁻¹, namely p₁, p₁₂, p₁₃, p₂₁, p₂₂, k₁, k₂, a₁, a₂, x_{c}, where p₁₁, p₁₂, p₁₃, p₂₁, p₂₂ are the parameters of the two polynomials used.

These unknown parameters can be found by any suitable type of optimization algorithm. One possible approach is to minimize the squared error of the PWM-like pulse widths before the system H, e.g. using the differences in x: Δx=M(yᵢ, e, v)−xᵢ, or the logarithm of those values. However, as the quantity y represents the actual PWM-like pulse width after x has passed through H, a better approach would be to compute the error in terms of y since this is the quantity of interest. For any computed value x_{M}=M(yᵢ), the closest value xⱼ in the sampled data set (xᵢ,yᵢ) can be used to look up yⱼ, such that the difference Δy=yᵢ−yⱼ can be computed and used as the error.

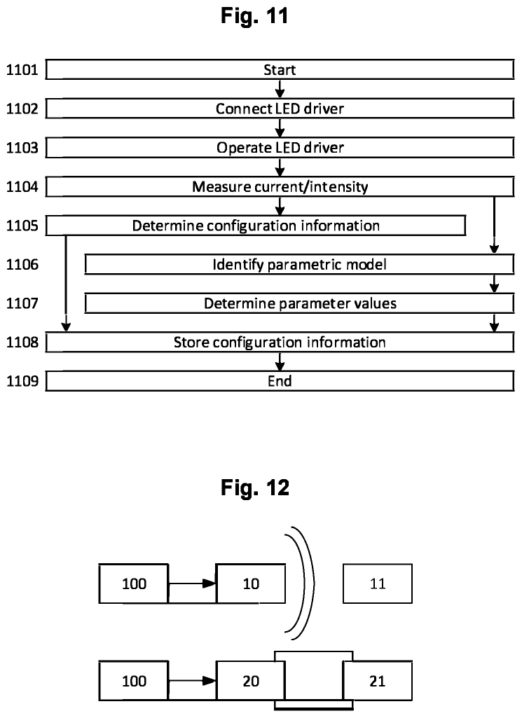

Generally, a method according to the second aspect of the invention for configuring the LED driver 100 for subsequent dimming of the LED load 10 is illustrated in FIG. 11 and pertains to the case in which the variable current being provided by the LED driver 100 to the LED load 10 is modulated using at least one transistor of the LED driver 100 based on the binary control signal described above.

As also described above, the binary control signal comprises or is made up of the repeated control signal pattern, that in turn at each time has an instantaneous time-averaged value as time-averaged over the control signal pattern used at the time in question. This instantaneous time-averaged value is denoted the “duty cycle” of the binary control signal above.

In a first method step 1101, the method starts.

In a subsequent step 1102, the LED driver 100 is connected to the LED load 10, or alternatively to a different load 20. See FIG. 12, showing the LED driver 100 driving the LED load 10, in turn radiating light that is detected by a light sensor 11; and the LED driver 100 alternatively driving a different electric load 20, a current through which is in turn measured by a current measuring sensor 21. Of course, the resulting current through the electric load 20, or the light emitted by the LED load 20 can be measured in many different direct or indirect ways, and that FIG. 12 is merely an example. For instance, a current clamp can be used to measure the current. Furthermore, instead of measuring the light emitted from the LED load 10, a current passing through the LED load 10 can instead be measured.

In a subsequent step 1103, the LED driver 100 is operated to provide the variable current to the LED load 10 or to the other load 20, in the general way described herein, using several different instantaneous time-averaged values for the binary control signal. It is noted that as one single run-through of the control signal pattern could suffice, in some embodiments it is advisable to use several repeated control signal patterns one after the other, as would be the case during continuous operation of the LED driver 100 at the dimming value corresponding to the control signal pattern in question. In other embodiments, multiple measurements can be made consecutively of different controlled duty cycle values. For instance, a slow dimmering up or down can be used, by gradually changing the duty cycle of the repeated control signal pattern after each or a few control signal pattern run-throughs, and measuring the current or light as described, providing a plurality of measurements merely involving performing a dimming action and taking the measurements.

In a subsequent step 1104, for each of the several different instantaneous time-averaged values, a respective measurement value is obtained, such as by reading the sensor 11 or 21, of a quantity, such as the emitted light or the current through load 20. This quantity, in turn, can then be, or be unambiguously related to, at least one of, firstly, an average current flowing through the LED 10 or the load 20, and, secondly, an average light intensity emitted by the LED 10. This way, a measured first relationship is obtained of the absolute or relative current/light intensity as a function of the instantaneous time-averaged value. It is understood that steps 1103 and 1104 can take place iteratively, whereby a first instantaneous time-averaged value is used and a first measurement is made, whereupon a second instantaneous time-averaged value is used and a second measurement is made, and so forth, for instance using a dimming control scheme as mentioned above. It is understood that this step 1104 of obtaining the measurement values and the first relationship can also be viewed as a step of automatically determining the first relationship based on the obtained measurement values.

The first relationship can be a value-by-value relationship between each absolute or relative current/light intensity as a function of each corresponding instantaneous time-averaged value. This is in contrast to the second relationship, described below, that defines the properties of the function itself, of the absolute or relative current/light intensity in relation to the instantaneous time-averaged value. It is realized that configuration information resulting from the presently described method can simply comprise a table or similar data structure with a set of absolute or relative current/light intensity together with corresponding instantaneous time-averaged values, useful for determining by simple lookup a particular instantaneous time-averaged value (with a corresponding determined repeated control signal pattern) based on a desired absolute or relative current/light intensity. Alternatively, the configuration information can comprise information regarding the second relationship, providing the possibility to calculate, based on the configuration information, the particular instantaneous time-averaged value given a desired absolute or relative current/light intensity.

In general, either an absolute value for the current or light intensity can be measured, or a relative value of the same metric. For relative values, the metric can be put in relation to a measured current or light intensity for a maximum dimming value, and then any measured value for a lower dimming value can be put in proportion to the value for the maximum dimming value. To illustrate this, consider a binary control signal with a fixed PWM-like frequency f and a duty cycle (with the above definition) Dᵢ, where i indicates the i:th measured sample. A duty cycle of 1.0 then results in maximum current through the load 20 or light intensity through the LED load 10. First, the maximum current or light intensity is measured by setting D=1, and resulting current is denoted Iₘₐₓ (and corresponding for the resulting light intensity in case that is instead measured). Now, for any given duty cycle Dᵢ, the current Iᵢ (or correspondingly the light intensity) can be measured and by normalizing this quantity with Imax, an equivalent duty cycle Pᵢ=Iᵢ/Iₘₐₓ can be computed. In the following calculations for determining the parametric model, the relative values are then simply used instead of the absolute values. Put more generally, the relative current and/or light intensity can be relative to a measured maximum current or light intensity, respectively.

For an ideal drive circuitry, the equivalent PWM-like duty cycle is equal to the generated PWM-like duty cycle, Pᵢ=Dᵢ, but as non-linear effects are present in the drive circuitry, Pᵢ≠Dᵢ.

By setting f to ƒₘᵢₙ and varying Dᵢ between 0 and 1, a collection of datapoints (Dᵢ, Pᵢ) can be gathered for constructing a model corresponding to the lowest PWM-like frequency. Likewise, by setting f to ƒₘₐₓ, datapoints for a model corresponding to the highest PWM-like frequency can be gathered.

Call these models Mₘᵢₙ and Mₘₐₓ respectively. These models take a number between 0 and 1 as input, corresponding to P, and outputs a compensation value between 0 and 1 corresponding to D:

D_{M}_{ₘᵢₙ}=Mₘᵢₙ(P)

D_{M}_{_{d max}}=Mₘₐₓ(P)

The compensation term is applied on each PWM-like pulse. Given a normalized light intensity I and a fixed PWM-like frequency of f, a control signal pattern of wanted pulse widths are generated. The models are applied on each respective PWM-like pulse in the control signal pattern. If one such pulse is called W, this pulse is related to the relative light intensity by the equation Wf=P. Likewise, the compensated term is related to the PWM-like duty cycle by scaling with 1/f:W_{compensated}=D/f. Putting this together, one gets W_{compensated}=M(Wf)/f. Hence:

$${W}_{min , compensated} = \frac{{M}_{min} ( W \cdot {f}_{min} )}{{f}_{min}} ;$$

$${W}_{max , compensated} = \frac{{M}_{max} ( W \cdot {f}_{max} )}{{f}_{max}}$$

To mitigate the simplification that was made, W_{min,compensated} and W_{max,compensated} can now be used to construct the final compensation term.

In case the repeated control signal pattern has a number of PWM-like pulses varying such that the PWM-like frequency is smoothly changed from ƒₘᵢₙ to ƒₘₐₓ, x can be defined to be a scaling quantity that varies from 0 to 1 over the range where the PWM-like frequency is changing from ƒₘᵢₙ to ƒₘₐₓ. A good weight factor has been empirically found to be b=sqrt(x), which is used for the final compensation term:

W_{compensated}=(1−b)·W_{min,compensated}+b·W_{max,compensated}.

In a subsequent step 1105, the configuration information, regarding a mapping of each of several different absolute or relative such current/light intensity values to a corresponding value for the instantaneous time-averaged value, is determined, based on the first relationship. Hence, the mapping can be direct, via a lookup table or similar, or it can be indirect, such as via a parametric model. In other words, configuration information determined based on the first relationship can also be configuration information in the form of information regarding the second relationship. Concretely, the configuration information may for instance be or comprise the parameters of a parametric model of the above-described general type.

In some embodiments, the method can also comprise, in a step 1106, identifying a parametric model of the second relationship. Such parametric model can then comprise one or several at least section-wise continuous functions determined by a set of parameters. Hence, the functions can be analytical functions as opposed to lookup tables or similar. The parametric model is generally useful for determining the mapping of each of the several different absolute or relative current/light intensity values to a corresponding instantaneous time-averaged value. It is realized that the identification of the parametric model can comprise using a predetermined parametric model or selecting one parametric model among several possible parametric models depending on the type of LED driver 100 used, or similar. The identifying of the parametric model itself does not have to entail determining or calculating the values of the parameters comprised or used in the identified parametric model.

Namely, in a subsequent step 1107, the respective values of the parameters that of the identified parametric model that provide a fit, such as a determined best fit according to some suitable optimization algorithm, of the at least one function to the second relationship can be determined. The fit can be determined using any suitable method wherein the second relationship is evaluated for each of the measurement values and corresponding instantaneous time-averaged values. Then, the configuration information will comprise the parameter values.

In some embodiments, the second relationship comprises the quote of

$$\frac{g ( x )}{g ( y )} ,$$

wherein g is a function, x is the instantaneous time-averaged value (of the repeated control signal pattern), and y is the absolute or relative current/light intensity. For instance, g(x)=x+0.1 yields the quote

$$\frac{( x + 0.1 )}{( y + 0.1 )} .$$

In another example,

$$g ( x ) = \frac{1}{( x + 0.1 )}$$

yields the quote

$$\frac{( y + 0.1 )}{( x + 0.1 )} .$$

Both of these formulations of g(x) have proven useful in practical embodiments.

Hence, a function z(y) can be approximated to the measurement points

$$z ( {y}_{i} ) = \frac{g ( {x}_{i} )}{g ( {y}_{i} )} ,$$

providing an approximated relationship

$$z ( y ) = \frac{g ( x )}{g ( y )} .$$

Solving for x, we get x=g⁻¹(z(y)g(y)). In other words,

$$\frac{g ( x )}{g ( y )}$$

is used during the calculation of the configuration information whereas g(x) and g⁻¹(x) are used once the configuration information is used to operate the LED driver 100.

In general, any bijective function g(x) that is continuous for all PWM-like pulse widths strictly greater than zero can be used in the following way: When finding parameter values for the parametric model, the quantity

$$\frac{g ( x )}{g ( y )}$$

is used and, when the parametric model with its parameter values is applied, both g and its inverse function g⁻¹ is used.

The parametric model can comprise one or several polynomials, and/or other primitive functions. Generally, the one or several functions can comprise at least one polynomial of degree one or higher, such as of degree two or higher, such as of degree three or higher. In some embodiments, the one or several functions can comprise two polynomials of degree one or higher, and/or other primitive functions, that are then interconnected by multiplication using a sigmoid function. Any two polynomials can be selected to approximate, by selection of the parameter values of the polynomials, a general shape of the second relationship on either side of a local minimum or maximum thereof.

The one or several functions can generally be defined in terms of a function ƒ(y), where an absolute value of a first derivative of ƒ(y) with respect to y, in other words |ƒ′(y)|, is decreasing, such as monotonously decreasing across the entire used range for y. y is the absolute or relative current/light intensity. For instance f can be the log or sqrt function. From a general point of view, the parametric model M can include a differentiable function ƒ(y) that takes the system variable y as input and has the property |ƒ′(y₀)|≥|ƒ′(y₁)| for all y₀ and y₁ that are within the defined range for y and where y₀ represents a shorter pulse width than y₁ and; f′(y) is the derivative of f with respect to y. In some embodiments, the input parameter y to M(y, e) is only used through f(y) such that M(y, e) can be written in the form M(y, e)=N(f(y), e), for some parametric model N.

In general, the sigmoid function can be defined in terms of two functions s′ and s″, selected to yield a continuous function at an expected local minimum or maximum of the second relationship as a function of the absolute or relative current/light intensity, and so that a derivative of the continuous function does not change sign.

Such sigmoid function can be of the above-described general type, using one or several exponential functions. However, other types of sigmoid functions can also be used.

For instance, by replacing exp(x) with

$$\frac{1}{{( 1 + k ( x - {x}_{c} + a ) )}^{n}}$$

but otherwise using the same parametric model construction approach as outlined above, a simpler sigmoid function can be created according to the following:

$${f}_{1} ( x ) = \frac{1}{{( 1 + {k}_{1} ( {x}_{c} - x + {a}_{1} ) )}^{n}}$$

$${f}_{2} ( x ) = 1 - \frac{1}{{( 1 + {k}_{2} ( x - {x}_{c} + {a}_{2} ) )}^{n}}$$

Let ƒ₁(x) be used when x<x_{c} and ƒ₂(x) be used when x≥x_{c}:

ƒ(x)=ƒ₁(x) if x<xc,ƒ₂(x) otherwise

Exemplary configuration parameter values are n=4, x_{c}=0.5, k₁=1 and k₂=2. n is here the polynomial degree of the sigmoid function and should be selected so that the degree is higher than the polynomial it needs to suppress. For instance, in case two polynomials are used in the parametric model with degrees two and three, respectively, the sigmoid function should have a degree of at least four. x_{c} is the center point of the sigmoid function, and defines the point where the two functions constituting the sigmoid function are bound together. k₁ and k₂ define the function's rate of change to the left and right side, respectively, of x_{c}.

Using continuity of the function and its derivative in the point x=x_{c}, a₁ and a₂ can be calculated according to the following:

$${f}_{1} ( {x}_{c} ) = {f}_{2} ( {x}_{c} ) and {f}_{1}^{′} ( {x}_{c} ) = {f}_{2}^{′} ( {x}_{c} ) ⇒ {a}_{1} = ( {s}_{1} - 1 ) / {k}_{1} and$$

$${a}_{2} = ( {s}_{2} - 1 ) / {k}_{2} , wherein$$

$${s}_{1} = b \cdot {s}_{2} , {s}_{2} = \frac{{( 1 + {b}^{n} )}^{1 / n}}{b} , and b = {( {k}_{1} / {k}_{2} )}^{1 / ( n + 1 )} .$$

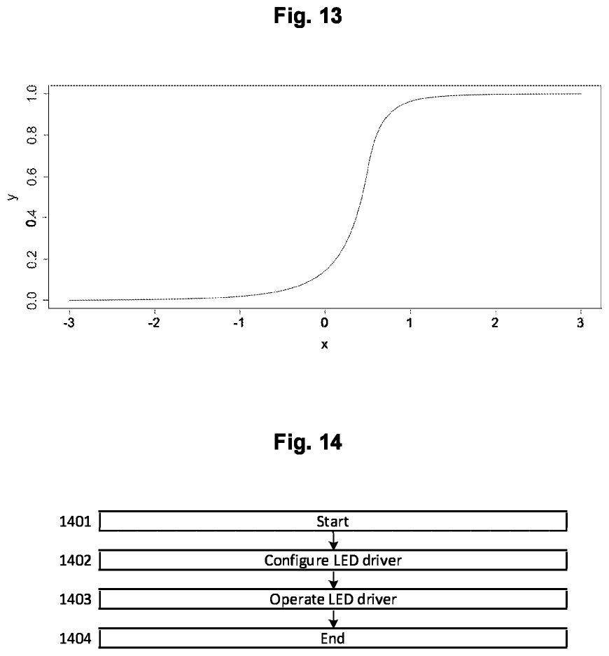

The exemplary parameter values provided above yields a sigmoid function as shown in FIG. 13. Generally speaking, by defining n, k₁, k₂ and x_{c}, a₁ and a₂ can be calculated using the above formulas to obtain a continuous and asymmetric sigmoid function, where a symmetric sigmoid function is achieved in the special case k₁=k₂.

The shape of the functional expression for ƒ₁(x) can generally be written as 1/P₁(x), where P₁(x) is a polynomial. The shape of ƒ₂(x) can generally be written as 1-1/P₂(x), where P₂(x) is another polynomial.

In addition to the direct or indirect information regarding absolute or relative current/light intensity and corresponding instantaneous time-averaged values, the configuration information can also comprise additional information. Such information can be determined automatically by the LED driver 100, or manually, in connection to the configuration of the LED driver 100, and can comprise, for instance, information regarding the number of pulses in the control signal pattern; a temperature of the LED diver 100 when obtaining the measurement values; and/or a maximum current provided to the LED driver 100. In some embodiments, the measurement of absolute or relative current/light intensity for various instantaneous time-averaged values can take place for several sets of such measurements, and each set of information regarding absolute or relative current/light intensity for various instantaneous time-averaged values can be stored as part of the configuration information together with, or associated with, such additional configuration information. In other words, configuration information regarding the first and/or second relationship can be stored together with corresponding information regarding number of pulses in the control signal pattern; temperature; and/or maximum current provided. Once this information is stored, it can be used using interpolation, as will be exemplified below, when driving the LED driver 100 in states lying between the measured states in a space spanned by the parameters number of pulses in the control signal pattern; temperature; and/or maximum current provided. Concretely, a current operating state as defined by these parameters can be used to determine the parameter values of the parametric model as a corresponding interpolation between established parameter values for known operating states.

In some embodiments, the configuration information can thus comprise at least two different number of pulses of the control signal pattern; at least two different temperatures of the LED driver 100 when obtaining the measurement values; and/or at least two different maximum allowed currents to be provided to the LED driver 100.

In a subsequent step 1108, the configuration information is stored for future use. The storing can be in the RAM area 134, elsewhere in the LED driver 100 or in an external storage unit. For instance, the configuration information can be stored in a non-volatile memory such as a ROM memory or a flash memory for use across consecutive power cycles of the LED driver 100. Once the configuration information is stored, it can be used for operation of the LED driver 100 whereby the configuration information is used to achieve a compensated binary control signal adapted for providing a desired light intensity of the LED driver 100, as will be further explained below.

In a subsequent step 1109, the method ends.

The other load 20 can correspond, with respect to electrical properties such as impedance, to a particular LED load 10 to be subsequently used with the LED driver 100. Similarly, the LED load 10 used for the configuration needs not be the same LED load 10 that is to be driven later by the LED driver 100 during operation, but it suffices that the load used for the configuration is similar to the LED load 10 to be used during lighting operation or that the configuration information can be translated or interpreted in an unambiguous manner knowing any differences regarding electrical properties between the load used for the configuration and the LED load 10 later driven by the LED driver 100.

FIG. 14 illustrates another method for operating the LED driver 100.

In a first method step 1401, the method starts.

In a subsequent step 1402, the LED driver 100 is configured using a method of the type illustrated in FIG. 11 and as described above. As is recalled, at the end of such configuration there is stored configuration information that can be used to produce a compensated binary control signal given a desired light intensity for the driven LED load 10.

In a subsequent step 1403, that can be performed at a later point, the LED driver 100 is then operated by determining a binary control signal corresponding to a particular desired current or light intensity, the determining of the binary control signal being performed using the stored configuration information. The binary control signal is then used to provide a variable current to the driver output 182 of the LED driver 100. More particularly, the variable current is provided based on the determined binary control signal in any of the ways generally described herein. It is preferred that the same LED driver 100 that was used in the calibration method is also used in the operating method. However, it is realized that the calibration can take several different aspects into consideration, as is described herein, and in particular the calibration information can comprise information that is not directly and specifically aimed to compensate for differing electric properties in component parts of the LED Driver 100. Therefore, it is also possible to perform, at least partly, the calibration method for a standard LED driver 100, and then use the resulting calibration information when operating a different LED driver 100 of the same standard type, such as several different same-type LED drivers 100.

For instance, and as has been described above in relation to the first aspect, the determining of the binary control signal can comprise adjusting (compensating) one or several pulse widths within the repeated binary signal pattern and/or adjusting a number of pulses within the repeated binary signal pattern; and the pulses within the repeated binary signal pattern can be adjusted so as to be distributed over a predetermined set of available pulse positions across the repeated binary signal pattern, such as a more or less evenly distributed such predetermined set of available pulse positions. The pulse compensator 137 can be arranged to perform the adjustment/compensation based on the previously determined and stored configuration information, such as a parametric model of one of the various types described herein.

As discussed above in connection to the first aspect, in embodiments of the invention the binary control signal frequency can be constant in the sense that the repeated control signal pattern has a constant set period length. In one of the examples provided, the frequency f=250 Hz. At low dimming levels the repeated control signal pattern may only contain one single pulse, meaning that the binary control signal is a 250 Hz PWM signal. Scaling the desired current or light intensity with the period time T=1/f, the determined parametric model can be used to calculate a compensated pulse width W_{compensated} provided a desired pulse width W. As there is only a single pulse in the control signal pattern, this can also be expressed unambiguously using a compensated duty cycle D_{compensated}, using the desired light intensity I:

$${W}_{Compensated} = {D}_{Compensated} \cdot T = \frac{{D}_{Compensated}}{f}$$

$$W = I \cdot T = \frac{I}{f} ⇒ I = W \cdot f ⇒ {W}_{Compensated} = \frac{{D}_{Compensated}}{f} = \frac{M ( I )}{f} = \frac{M ( Wf )}{f} ⇒ {W}_{Compensated} = \frac{M ( Wf )}{f} .$$

Given this relation, M can now be applied to each PWM-like pulse, even as the frequency changes as new pulses are added to the repeated control signal pattern. However, there is a problem with this if the drive circuitry 140 is dependent on the instantaneous time-averaged value: If it is assumed that there is only one pulse during a 250 Hz cycle, M is applied only once and since the signal is the same as when the calibration was performed a perfect inverse model is achieved. If it is instead assumed that the average light intensity or current is the same but the pulse was divided into two separate and evenly distributed pulses over the 250 Hz cycle, effectively forming a 500 Hz PWM signal, M will need to be applied twice. This causes the signal going into the drive circuitry 140 to be slightly different, in turn causing the external variables to deviate from the values used when doing the calibration (the instantaneous time-averaged value is different). If more pulses were to be added to the repeated control signal pattern, even under constant total duty cycle of the control signal pattern, the deviation would grow. In case the maximum number of pulses in a 250 Hz cycle is 128, a maximum frequency of 32 kHz is reached.

To solve this problem, two parametric models can be constructed: one M_{250 Hz}(I) which is optimized for a 250 Hz binary control signal and another one M_{32 kHz}(I) which is optimized for a 32 kHz binary control signal. For intermediate frequencies, W_{Compensated} can then be calculated using interpolation between these two extreme-point models. Then, let x be a value between 0 and 1, such that x assumes the value 0 up to a point where the first pulse has reached the threshold pulse width (as described in the example in connection to the first aspect). As the second pulse is added and starts growing, x>0, and thereafter grows linearly up to a point where the maximum number of pulses is reached, at which point x=1. Then, W_{Compensated} can be determined according to the following empirically developed equation providing a good fit under the frequency change that occurs in this and in similar examples:

W_{Compensated}=(1.0−\sqrt{x})−W_{250 Hz,Compensated}+\sqrt{x}·W_{32 kHz,Compensated}.

Finally, given W_{Compensated} a model has been formulated that takes into consideration component variations, electric properties of the drive circuitry 140 and the drive switch 180, and in particular behavior due to used transistors and signal frequency variations.

Generally, in some embodiments the determining of the binary control signal in step 1403 can comprise determining a number of pulses within the control signal pattern. Then, the selection of the binary control signal to fit the desired average current or light intensity can be made according to an interpolation between a first and a second respective expression for the binary control signal. The first expression can be determined based on the configuration parameters for a first number of pulses within the control signal pattern and the second expression can be determined based on the configuration parameters for a second number of pulses within the control signal pattern. The interpolation can be performed for a current number of pulses within the control signal pattern between the first number of pulses and the second number of pulses. When dimming between a first dimming value and a second, different, dimming value, several different interpolations can hence be used. For instance, the interpolation can be continuous from the first to the second dimming value.

Further generally, the first and second expressions can be determined based on a respective pulse width within the control signal pattern.

Further generally, the interpolation can be performed using as a weight factor, for the first and second expressions, a square root of a normalized value for the current number of pulses.

Another example takes into consideration the fact that the drive circuitry 140 itself can be dependent on the average value of the binary control signal s. This fact will be discussed in detail below in connection to the third aspect. More particularly, the average value of s can in some embodiments alter the rise and fall times for H. To take this into consideration, two models at the two extremes were used, one when the rise and fall times were at the slowest rates of change, and one when they were at the highest rates of change. This gave two models, M_{O} and M₁ respectively, which would then be fused together using a weight function w(e).

M(y,e,v)=(1−w(e))·M₀(y,e₀,v₀)+w(e)·M₁(y,e₁,v₁),

where w(e)=sqrt(s_{avg}). All external sets e, e₀ and e₁ contains the variable s_{avg} and e₀ and e₁ represent the conditions that were used when creating M₀ and M₁ respectively. In general, the methodology described above can be used for any other variable that may affect the drive circuitry 140 or the characteristics for the power transistor 181. For example, the external sets could contain information about the temperature of the system or the load size of the led load 10. Assuming that a dependency on temperature is to be modelled, by way of example, then two models M₃(y, e₃, v₃) and M₄(y, e₄, v₄) could be constructed, where e₃ and e₄ correspond to the different temperatures that were used during the calibration. When applying these models, the current temperature is then measured (and is contained in the variable e in question) and a similar interpolation can then be done using another weight function w(e).

Further generally, the model can be written as a weighted sum of submodels M(y, e)=Σᵢ wᵢ(e)·Mᵢ(y, e), where wᵢ(e) is a weight function dependent on external variables.

In a subsequent step 1404, the method ends.

It is realized that the binary control signal selected, using the configuration information and to match a desired light intensity or current as described above, can be considered to constitute a “compensated” binary control signal in the sense that the binary control signal that is actually used (such as fed to the drive circuitry 140) is not a naïve binary control signal devised with a particular control signal pattern duty cycle corresponding to the desired light intensity or current, but being compensated in relation to such naïve binary control signal to take the specific electric properties of the drive circuitry 140, the drive switch 180, and so forth into consideration to actually produce the desired waveform corresponding to the naïve binary control signal at the output 182 of the LED driver 100 and into the LED load 10.

It is realized that the various ways and approaches to determine the configuration information presented and exemplified herein can be combined in various ways, depending on the concrete needs of the embodiment at hand.

In particular, given measured current or light intensity, as well as set duty cycle (the binary control signal), there are many ways to identify and determine parameterized models to achieve a desired precision of the inverse model D(I). The inverse model D(I) will generally to a high degree depend on how the drive circuitry 140 and drive switch 180 is implemented. For instance, the parameterized model will likely differ depending on if the drive circuitry 140 uses a variable resistance driven by a BJT transistor or a DAC (Digital Analog Converter) (see below in relation to the third aspect). One example of another parameterized model that has been used by the present inventors is one where D(I) is calculated as

D=exp(x−((k₁·x+m₁)−(atanf(k₂·x+m₂)+m₃)+m₄)),

where x=log(I) and the other parameters are constants in the model being adapted after the measurement data, the parameters being determined using some suitable and per se conventional optimization method.

### Third Aspect of the Invention

Turning now specifically to the third aspect, the LED driver 100 comprises the drive circuitry 140 and the drive switch 180 as already described above. The drive switch 180 is arranged to provide the variable current or voltage to the LED load 10 as a switched electric signal. The microcontroller 130 is arranged to provide a control signal, such as a compensated binary control signal as described in connection to the second aspect, to the drive circuitry 140 to in turn, such as via the drive switch 180, provide the variable current or voltage to the LED load 10.

In fact, the third aspect presupposes a binary control signal source, arranged to provide the binary control signal as a square wave, the binary control signal having a control signal pattern that is repeated over time to form the binary control signal as described above. As also described, the control signal pattern at each time has an instantaneous time-averaged value being or corresponding to a time-average of the signal over the control signal pattern used at the time in question. The binary control signal source can be the microcontroller 130 itself, but it is realized that the third aspect of the invention in principle works also with a different internal or external binary control signal source, such as a separate piece of hardware arranged to provide the binary control signal to the drive circuitry 140.

The LED driver 100, and in particular the one or several drive switches 180, also comprises one or several electric driver outputs 182 as described above, each arranged to provide the drive current to the LED load 10 based on the binary control signal to drive one or several LEDs of the LED load 10.

As is illustrated in FIG. 15, showing an exemplary LED driver 100 connected to an LED load 10 for driving the LED load 10, the LED driver 100 comprises a power transistor 181. In the example shown in FIG. 15, the power transistor 181 in fact constitutes the switch 180. The power transistor 181 is arranged to power the LED load 10 via the driver output 182, and has a power transistor control terminal 181a as well as a pair of different terminals 181b, 181c. The control terminal 181a is arranged to accept, from the drive circuitry 140, a voltage or current signal arranged to modulate the power transistor 181. One of the other terminals 181b, 181c (in the example shown in FIG. 15 the terminal 181c) is connected to the driver output 182. The power transistor 181 can be a FET (Field-Effect Transistor), such as a MOSFET.

The drive circuitry 140 is connected to the power transistor control terminal 181a.

The exemplary LED driver in FIG. 15 is a single-channel LED driver 100. It is realized that, in the case of a multi-channel LED driver, the switch 180 and other relevant components would be duplicated and provided one for each channel.

In FIG. 15, the positive pole of the LED load 10 is connected to the feed voltage, and the negative pole is connected to the drain terminal of an N-channel MOSFET transistor (the power transistor 181). The source terminal of the transistor 181 is connected to ground, and its gate is connected to the drive circuitry 140. To manage parasitic inductance from long cables to the LED load 10, causing slow current decays, a Schottky diode 190 is provided, arranged to provide the current with a way back. It is realized that any such Schottky diode 190 can also form part of the LED driver 100. It is realized that other types of diodes can be used as alternatives to the Schottky diode 190, such as a standard silicon diode.

It is realized that the switch 180 can generally be provided in other ways. For instance, a GaN transistor could be used instead of the MOSFET. P-channel MOSFETs could be used, and the connection point of the transistor could be to VDC.

As described above, the binary control signal can be generated directly by a binary control signal generator 136 of the microcontroller 130, or be provided from an external source.

From a general point of view, a MOSFET transistor is excellent for uses where it is either completely on or completely off. However, power losses arise at the transition during which the transistor is switched on or off. Therefore, shortening such transition times decreases such losses. This can be achieved by designing the drive circuitry 140 to be fast, but as discussed above this leads to other problems in terms of uneven light at low dimming levels.

One common way to limit the speed of a drive circuit is to connect a resistance in series with gate drive logic circuitry. However, such approach would limit the maximum PWM-like frequency of the LED driver 100, since the power losses are directly proportional to the operating frequency.

However, the present inventors have realized that the binary control signal can be designed so that the PWM-like frequency is low at low dimming levels and high at high dimming levels. In fact, this is the case using many reasonable dimming approaches when operating according to the principles described herein, such as the one using PWM-like pulses described above in connection to the first aspect. Furthermore, the driver circuitry 140 can be designed to be slow at relatively low dimming levels and fast at relatively high dimming levels. This way, it is possible to achieve both even lighting at low dimming levels and high efficiency at high dimming levels, despite the PWM-like frequency then being higher. This will now be described and exemplified.

The drive circuitry 140 is arranged to construct the electric control signal needed to operate the switch 180, in turn powering the LED load 10. Given the binary control signal for driving the LED load 10 on and off, the LED driver 100 should generate a drive signal with the right voltage/current levels, and the drive circuitry 140 should achieve this end goal while providing a control signal with suitable rise and fall times for the concrete embodiment at hand. Specifically, when dealing with switches 180 based on n-channel FET transistors, a suitable positive voltage level should be produced on the power transistor's 181 gate terminal 181a, with respect to its source terminal 181b.

For FET-transistors in general, the main contributors to power losses are switching losses and conduction losses. In order to minimize losses without using an unnecessary costly transistor, both loss types are usually balanced such that they contribute to the losses in the same order of magnitude.

However, for a constant-voltage LED load 10, the current through the LED load 10 is strongly correlated with the control signal going into the switch 180, which means that additional factors must be considered. Firstly, a pulse being generated will have some physical length inside the electrical traces across the LED load 10. As discussed above, for an LED strip of 5 m physical length and with the speed of light inside copper roughly being half of that in vacuum, it takes about 5/150e6=33 ns for the signal to travel through the whole LED strip. After reaching the other end of the LED strip, the wave will be reflected and go in the other direction. If the length of the wave is in the same order of magnitude as the LED strip, visible interference patterns may emanate. This is usually not a problem for conventional LED drivers because at their lowest possible dimming level (such as 0.1%), the pulses are long enough to make the resulting interference pattern invisible. Putting this into mathematical rigor, if a PWM frequency of 230 Hz and dimming level is 0.1% is used, the pulses being generated are 0.001/230=4348 ns, equivalent to a pulse of length 652 m.

Keeping in mind that the pulses being generated are of rectangular shape, higher frequencies than the base frequency (e.g. 230 Hz) are contained in the signal (harmonics). To avoid any interference patterns, frequencies up to at least 10 times the base frequency should be considered. For conventional LED drivers, this is still not a problem because the equivalent pulse length is then 65.2 m, still a lot longer than a normal LED strip. However, for dimming down to lower levels, such as 0.01%, this equivalent length gets further reduced down to 6.52 m, which is of comparable length to conventional LED strips and this leads to the risk of interference patterns becoming visible.

Therefore, pulses of rectangular shape cannot be used for dimming to darkness with high light quality, even at low PWM frequencies, assuming the dimming level has to go below 0.1%.

An additional problem arises when high varying currents are flowing through a wire, in the form of crosstalk. If high-frequency content of the signal has a corresponding wavelength that is comparable to the length of the wire, the wire will start acting as an antenna, possibly transferring energy to nearby wires. For multi-channel LED strips, this can become a problem as it may produce light from channels that should be off, in turn potentially causing problems such as color errors.

Hence, the frequency contents of the drive signal to the LED load 10 should be relatively low at relatively low dimming levels, but can be relatively high at relatively higher dimming levels.

One way to reduce the frequency contents of the drive signal is to reduce the frequency contents of the control signal going to the switch 180. For MOSFETs, this can be done by slowing down the charging and discharging of the gate capacitance, such as by increasing the series resistance between the drive circuitry 140 and the transistor 181 gate 181a. This leads to longer rise- and fall-times.

However, by doing so the switching losses will increase, which constrains the viable PWM-like frequency of the binary control signal, in turn leading to possible flicker. Thus, in order to increase frequency when intensity is increased, while at the same time being both efficient and being able to dim all the way down to complete darkness, slow rise and fall times can be used for low light intensities while fast rise- and fall times can be used for higher light intensities.

As discussed herein, the LED driver 100 can be designed so that an average light intensity of the connected LED load 10 is positively correlated with the number of pulses generated per time unit. Therefore, the average intensity can be used as a control signal to the drive circuitry.

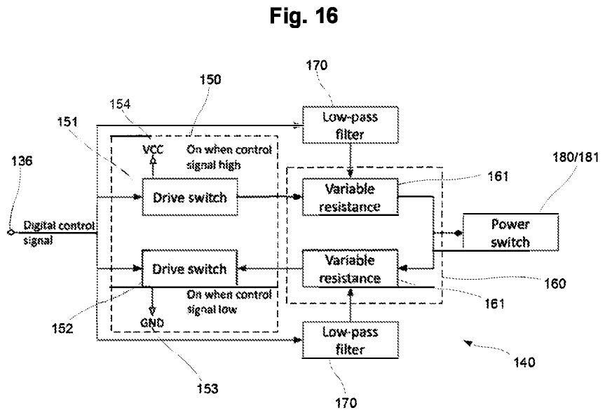

A block diagram of an exemplifying drive circuitry 140 is shown in FIG. 16. The binary control signal is delivered by the (internal or external) binary control signal generator 136 to a signal averaging part 170, in turn providing a time-averaged signal value representing a positive and/or negative value of a general signal level currently used, which value can be correlated to the currently used repeated control signal pattern. In general, the drive circuitry 140 is arranged to receive or produce one or more level signals (such as the time-averaged signal values), each such level signal being provided as an increasing or decreasing function of an increase in the instantaneous time-averaged value.

The respective time-averaged signal values are then used to control a first and second variable, current-controlling resistances 161 (first and second current-throttling parts), each such current-controlling resistances 161 in turn being connected in series between, firstly, a respective first 151 or second 152 switch transistor (the switch transistors 151, 152 together forming a switch 150 of the drive circuitry 140) and, secondly, the switch 180 (the power transistor 181). More particularly, it is the control terminal 181a of the power transistor 181 that is connected in series in the way discussed here. The first switch transistor 151 is connected to a high voltage 154 (such as a drive power supply 123 of the power supply 120), and is arranged to provide a current via the first variable resistance 161 to the switch 180 (the control terminal 181a) as a function of the provided binary control signal provided from the binary control signal generator 136. Correspondingly, the second switch transistor 152 is connected to a low voltage 153, in this example ground, and is arranged to provide a current via the second variable resistance 161 from the switch 180 (the control terminal 181a) as a function of the provided binary control signal provided from the binary control signal generator 136. The exemplary circuit shown in FIG. 16, being a push-pull circuit, employs two such current-throttling parts 161, one arranged to throttle the current to the gate terminal 181a and the other arranged to throttle the current from the gate terminal 181a. In other configurations, only one current-throttling part 161 could be used.

Generally, the drive circuitry 140 can comprise the drive circuitry switch 150, which is arranged to selectively provide an electric coupling between the control terminal 181a of the power transistor 181 to either the low voltage 153 or to the high voltage 154, in dependence of an instantaneous low value or high value of the binary control signal. It is realized that such coupling can be mediated by the variable resistances 161 but possibly also additional electric components. The coupling can also be a direct connection, through and via the variable resistances 161.

Further generally, the drive circuitry 140 can comprise one or several such variable resistances 161, arranged to provide a respective variable resistance along the electric coupling, the variable resistance of each of the variable resistances 161 being arranged to vary as a function (such as an increasing or decreasing function, depending on how the level signal is defined and produced) of the level signal, resulting in that an increase in the instantaneous time-averaged value results in an increase in an instantaneous current flowing to or from the control terminal 181a of the power transistor 181. For the upper part of the circuit in FIG. 16, the inverted binary control signal relative to the high voltage Vdrive is averaged and used as the level signal, so that a larger negative value signal translates into a larger current flowing to the control terminal 181a. For the lower part, the non-inverted binary control signal relative to the low voltage GND is averaged and used as the level signal, so that a larger positive signal translates into a larger current flowing from the control terminal 181a.

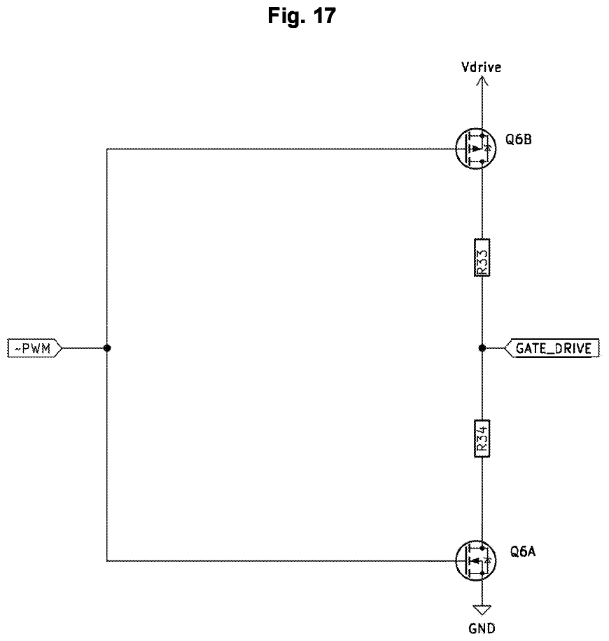

To explain this setup more closely, first a conventional push-pull drive circuit can be considered, shown in FIG. 17. The push-pull drive circuit of FIG. 17 is based on a couple of MOSFET transistors, one n-channel and one p-channel. This circuit uses individual resistors to tune the rise and fall times individually.

In the schematic shown in FIG. 17, ^{~}PWM is the inverted input control signal. When the binary control signal (in these examples denoted “PWM”) is low, ^{~}PWM is high and will turn on Q6A and turn off Q6B. This will discharge the gate of the power transistor, connected to GATE_DRIVE, through R34. When PWM is high, ^{~}PWM is low and will turn off Q6A and turn on Q6B. This will charge the gate of the power transistor through the other resistor, R33.

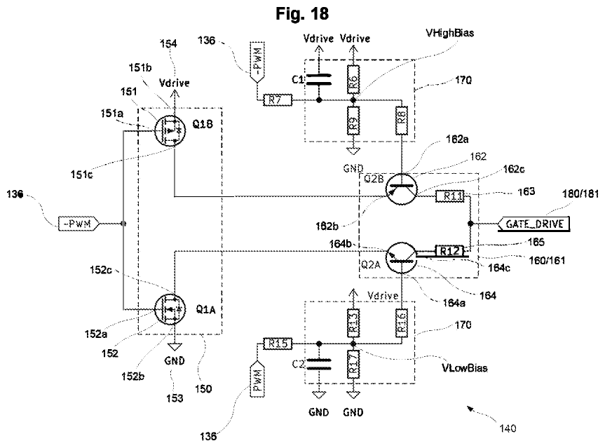

Now consider the more complex circuit shown in FIG. 18, in which resistors 163, 165 are introduced and wherein the combination of a first current-controlling transistor 162 and the resistor 163 together constitute a first current-throttling mechanism 161 and a second current-controlling transistor 164 together with the resistor 165 constitute a second current-throttling mechanism 161. Both current-throttling mechanisms 161 depend on the average value of the binary control signal PWM in a way corresponding to what has been discussed above.

In FIG. 18, a first current-controlling PNP transistor 162 Q2B and a second current-controlling NPN transistor Q2A 164 are connected in series with the push-pull circuit shown in FIG. 17. In the example shown, the current-controlling transistors 162, 164 are BJT transistors, comprising a respective base terminal 162a, 164a; a respective emitter terminal 162b, 164b; and a respective collector terminal 162c, 164c. In other embodiments, the current-controlling transistors 162, 164 can be MOSFET transistors with corresponding gate, source and drain terminals.

In general, the variable resistance part 160 can comprise one or several current-throttling parts 161, in this case the current-controlling transistors 162, 164, in combination with the resistors 163, 165, arranged to throttle the current that can pass through the electric coupling and therefore limiting a rise-time and/or fall-time of an electric signal provided to the power transistors 181 control terminal 181a, in turn controlling the rise-time and/or fall-time of the current through the drive output 182 as the switch 150 switches the electric coupling between the low voltage 153 and the high voltage 154. As mentioned, the variable resistance part 160 can be arranged to vary the resistance as a function, such as a decreasing function, of the level signal. This function can be a monotonous function.

Further generally, the variable resistance part 160 can comprise one or several current-controlling transistors (in this case again 162 and 164), configured so that a current flowing through the electric coupling flows across the current-controlling transistor 162, 164 in question, via the current-controlling source/emitter terminal 162b, 164b and the current-controlling drain/collector terminal 162c, 164c. The level signal can be coupled to the current-controlling gate/base terminal 162a, 164a so that an increase in the instantaneous time-averaged value results in a higher instantaneous current across the current-controlling source/emitter terminal 162b, 164b and the current-controlling drain/collector terminal 162c, 164c. This way, a faster drive circuitry 140 is achieved both for the rise and fall flanks of the current waveshape output to the LED load 10, for higher dimming values, and vice versa.

Each of the current-controlling transistors 162, 164 can then be series-connected to a respective resistor 163, 165 along the electric coupling in order to limit the currents to desired values.

Moreover, the switch 150 can comprise one or several switch transistors 151, 152, each having a respective gate/base terminal 151a, 152a, a respective source/emitter terminal 151b, 152b and a respective drain/collector terminal 151c. Generally, the gate/base terminal 151a, 152a of each such switch transistor 151, 152 can be connected to the positive or negative binary control signal, in the form of a voltage or current varying according to the value of the binary control signal. In the case illustrated in FIG. 18, the two switch transistors 151, 152 together form and provide a push/pull circuit, the two switch transistors 151, 152 being arranged between two different voltage potentials in the form of the low voltage 153 and the high voltage 154. Also, the power transistor 181 control terminal 181a is coupled to a point between the two switch transistors 151, 152. For the case using BJT transistors, they can be connected either as so-called “common emitter” (emitter terminals being interconnected) or “common collector” (collector terminals being interconnected). For the case using MOSFET transistors, the drain terminals can be interconnected.

In FIG. 18, the switch transistors 151, 152 are each a FET. However, by modifying the circuitry layout BJT transistors can be used instead as the switch transistors 151, 152.

As is also specifically exemplified in FIG. 18, the variable resistance part 160 can comprise both the first current-controlling transistor 162, which is connected so that a current flowing through the electric coupling between the first switch transistor 151 and the power transistor 181 control terminal 181a passes through the first current-controlling transistor 162, and also the second current-controlling transistor 164, which is connected so that a current flowing through the electric coupling between the second switch transistor 152 and the power transistor control terminal 181a passes through the second current-controlling transistor 164. In other words, the electric coupling discussed herein can consist of two separate connection lines, both terminating to source or sink current to the control terminal 181a but each being operable only during either the rise or the fall of a pulse.

Regarding the signal averaging part 170, it can be arranged to provide the level signal to be, or to correspond to, the instantaneous time-averaged value or to the inverse of the instantaneous time-averaged value as discussed above. Specifically, the signal averaging part 170 can comprise a low-pass filter or a digital to analog converting circuitry, arranged to provide the level signal as a smoothed or time-averaged, positive or negative, version of the binary control signal. The level signal itself can be a current or a voltage corresponding to the instantaneous time-averaged value in any of said manners.

One goal of the drive circuitry 140 is to minimize switching losses in a power transistor 181 that is driven with a control signal designed such that low PWM-like frequencies are used for low light intensities and higher PWM-like frequencies are used for higher light intensities, and to provide switching characteristics that are slow for low light intensities. Put differently, the rise and/or fall-times at low light intensities should or could be so long so that if the intensity and the PWM-like frequency were to be increased, an unpractical amount of heat risks being generated. In cases wherein the time-averaged value of the binary control signal is positively correlated to the number of pulses per second (the PWM-like frequency), the time-averaged value of the binary control signal can be used as a level signal for controlling a variable resistance. On the other hand, this also means that the inverse of the time-averaged binary control signal is anticorrelated with the number of pulses per second and can also be used for controlling a variable resistance. Hence, the level signal can either be, or be correlated with, the time-averaged binary control pattern or be, or be correlated with, the negative time-averaged binary control pattern. Either way, the goal is still to lower the variable resistance when the light intensity increases and the variable resistance will be configured to change with the level signal to achieve this goal.

In examples provided herein, the average value of the binary control signal is useful for controlling an NPN BJT transistor, while the average value of the inverse binary control signal is useful for controlling a PNP BJT transistor. Likewise, if the current-limiting transistor would be a MOSFET, the non-inverted signal would typically be useful for an N-channel MOSFET while the inverted signal would be useful for a P-channel MOSFET.

Hence, to assume that the PWM-like frequency increases when the time-averaged value of the binary control signal increases is equivalent to assumed that the PWM-like frequency increases when the light intensity emitted from the LED load 10 increases. A level signal can now be constructed that is either increasing or decreasing with light intensity, depending on if it was based on the non-inverted or the inverted binary control signal, respectively. The level signal is then used to control a variable resistance such that when light intensity is increased, the variable resistance is decreased.

As noted above, the level signal can be provided as a function of the instantaneous time-averaged value. It is, of course, noted that the level signal in some embodiments is not calculated directly as a function of the instantaneous time-averaged value, but can instead be calculated so as to correlate with the instantaneous time-averaged value in some other way. For instance, the level signal can be calculated based on the control input 110 and to (in a way corresponding to what has been said above) be calculated or determined as an increasing or decreasing function of an increase in such a control signal that in turn is correlated with the instantaneous time-averaged value.

Returning to the added components of the circuit shown in FIG. 18, one can first observe the differences between FIG. 17 and FIG. 18, and note that the resistors R11 and R12 together with the transistors Q2A and Q2B, are not mounted in FIG. 17, but that resistors R33 and R34 are. In this case, a traditional push-pull drive circuit is achieved, based on the two MOSFET transistors Q6A and Q6B. The inverted signal ^{~}PWM is used to control the gates of Q6A and Q6B, and the high voltage value for ^{~}PWM is the same as the voltage Vdrive. R33 controls how fast the gate connected to GATE_DRIVE is charged, and R34 controls how fast it is decharged. This provides the same rise time and fall time for the current to the LED load 10, irrespective of the duty cycle (defined as above) of the repeated control signal pattern PWM.

Now, the situation can be investigated when R11, R12, Q2A and Q2B are used instead of R33 and R34, as is the case in FIG. 18. The bias current to the BJT transistors Q2A and Q2B will now decide the effective resistance to GATE_DRIVE. Looking at the lower part of the circuit, the PWM signal first passes through a low-pass filter R₁₅ and C₂. These components are used to create a constant voltage level that is proportional to the duty cycle of the PWM signal. The low-pass filtered signal is now combined with a resistor divider R₁₃ and R₁₇, so that a suitable selected mapping between duty cycle and bias voltage can be created, (0%, 100%)→(Vₘᵢₙ, Vₘₐₓ). R₁₆ is then used to create a bias current to the BJT transistor Q2A, which is amplified by the amplification factor h_{FE} of the transistor Q2A. The current passing through R₁₂ is therefore determined by the duty cycle as long as the transistor is operating in its active region. Once it has been saturated, the current is instead limited by R₁₂.

For analysis of the bias network, the circuits in FIG. 19 can be observed. As the PWM signal is fed into R_{c}, the signal Vₒᵤₜ results, that will vary in a linear manner between Vₘᵢₙ and Vₘₐₓ. When the duty cycle is 0%, Vₒᵤₜ=Vₘᵢₙ and when the duty cycle is 100%, Vₒᵤₜ=Vₘₐₓ. Therefore, the circuit can be redrawn as shown in FIG. 19, so that an analytical expression for Vₘᵢₙ and Vₘₐₓ can be derived.

By using the principles for resistance laws (Ohm's law and Kirchhoff's current law), Rₐ and R_{b} can be calculated given R_{c}:

$${R}_{a} = {R}_{c} \frac{( {V}_{max} - {V}_{min} ) {V}_{d}}{{V}_{min} {V}_{c}} {R}_{b} = \frac{{V}_{min} {R}_{a} {R}_{c}}{{V}_{d} {R}_{c} - {V}_{min} ( {R}_{a} + {R}_{c} )} .$$

Since C and R_{c} are used together as a low-pass RC filter, values are assigned to them so that they together achieve a desired suppression of the varying signal so that a DC voltage is created. The cut-off frequency f_{c} for this filter, i.e. the frequency when the filter starts dampening the signal, thereby becomes a design parameter and defines C and R_{c} by

$${f}_{c} = \frac{1}{2 π {R}_{c} C} .$$

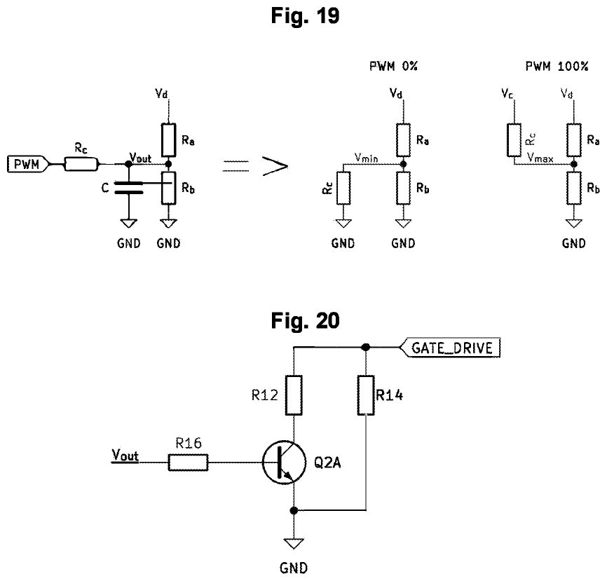

What is now left is to determine the resistance R16 given the voltage Vₒᵤₜ. When Q1A is closed, the circuit is simplified according to FIG. 20. Since the base-emitter voltage V_{be} in an NPN transistor can be modelled as a forward diode, Shockley's diode equation can be used here also, and the current I_{b} as a function of the voltage Vₒᵤₜ will follow a curve similar to the above-described for an LED in series with a resistor. Hence, Shockley's diode equation yields:

$${V}_{b e} = n {V}_{T} \cdot ln ( {I}_{b} / {I}_{S} ) and {I}_{b} = {I}_{s} \cdot exp ( \frac{{V}_{b e}}{{nV}_{T}} ) ,$$

where V_{T} is the thermal voltage, n is the ideality factor and I_{S} is the scale factor current.

Now, Vₒᵤₜ can be described as a function of V_{be}:

$${V}_{out} = {V}_{b e} + {I}_{b} \cdot {R}_{16} = {V}_{b e} + {R}_{16} {I}_{S} \cdot exp ( \frac{{V}_{b e}}{{nV}_{T}} ) .$$

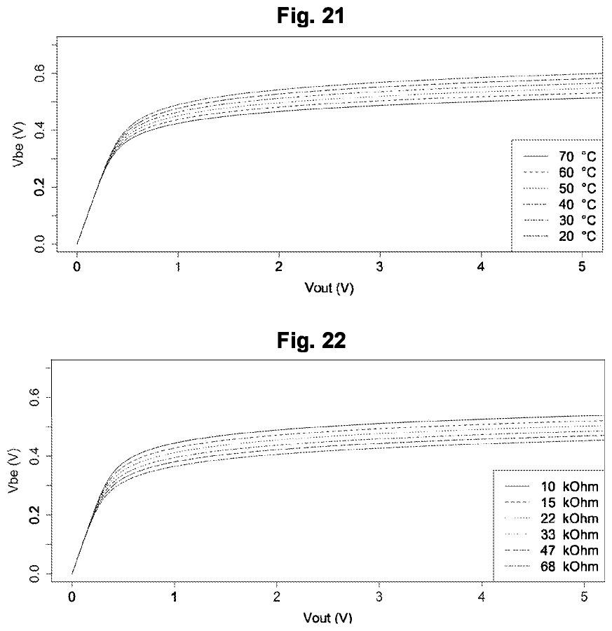

Example values for n and I_{S} for a silicon-based diode is n=1.7 and I_{S}=2.5 nA, and are used in the graphs shown in FIGS. 21 and 22.

For a given voltage Vₒᵤₜ, an expression is now desired for the effective resistance Rₑ(Vₒᵤₜ) so that a resistance ratio K=Rₑ(Vₘᵢₙ)/Rₑ(Vₘₐₓ) can be calculated. As the switching losses in the power transistor 181 is more or less proportional to the rise and fall-times of the electric signal delivered to the power transistor's 181 control terminal 181a, a twice as fast rise and fall-time will result in half as large power losses. Thus, if K=2, only half as large power losses will be generated for binary control signals with high enough average values, as compared to a circuit with the same value for Rₑ(Vₘᵢₙ) but with a resistance ratio of K=1 (corresponding to the case when a constant, non-variable resistance is used). Thus, the resistance ratio K measures the potential efficiency gain compared with a conventional circuit.

A simplified analysis is first motivated by plotting V_{be} as a function of Vₒᵤₜ given the values above and R₁₆=10 kOhm (FIG. 21). In this graph, it can be seen that the voltage V_{be} is rather stable in the linear region, whereas it is temperature dependent. V_{be} also depends on the choice of R₁₆ (FIG. 22), but is also here rather stable for various resistance values. Therefore, one can try to regard V_{be} as constant, and further assume the voltage GATE_DRIVE to be equal to Vdrive in FIG. 18, so that the effective resistance is calculated at the time point when the gate of the MOSFET is just beginning to be charged. Then, the equivalent resistance of R₁₂ in series with the transistor can be defined as R_{Q}. Ohm's law, together with the amplification factor h_{FE} for the transistor, can be used to calculate R_{Q} when the transistor is operating in its active region:

$${R}_{Q} = \frac{{V}_{drive}}{{I}_{CE}} = \frac{{V}_{drive}}{{h}_{FE} {I}_{b}} = \frac{{V}_{drive}}{{h}_{FE}} \cdot \frac{{R}_{16}}{{V}_{o u t} - {V}_{b e}} .$$

Now, Rₑ(Vₒᵤₜ) can be determined as a parallel connection of R_{Q}(Vₒᵤₜ) and R₁₄. Let R_{Q1}=R_{Q}(Vₘᵢₙ) and R_{Q2}=R_{Q}(Vₘₐₓ). Then:

$$K = \frac{{R}_{e} ( {V}_{min} )}{{R}_{e} ( {V}_{max} )} = \frac{{R}_{Q 1} ‖ {R}_{14}}{{R}_{Q 2} ‖ {R}_{14}} = \frac{\frac{{R}_{Q 1} {R}_{14}}{{R}_{Q 1} + {R}_{14}}}{\frac{{R}_{Q 2} {R}_{14}}{{R}_{Q 2} + {R}_{14}}} = \frac{{R}_{Q 1} ( {R}_{Q 2} + {R}_{14} )}{{R}_{Q 2} ( {R}_{Q 1} + {R}_{14} )} = \frac{\frac{{V}_{drive}}{{h}_{FE}} \cdot \frac{{R}_{16}}{{V}_{min} \cdot {V}_{be}}}{\frac{{V}_{drive}}{{h}_{FE}} \cdot \frac{{R}_{16}}{{V}_{max} \cdot {V}_{be}}} \cdot \frac{{R}_{Q 2} + {R}_{14}}{{R}_{Q 1} + {R}_{14}} ⇒ K = \frac{{V}_{max} - {V}_{be}}{{V}_{min} - {V}_{be}} \cdot \frac{{R}_{Q 2} + {R}_{14}}{{R}_{Q 1} + {R}_{14}} = \frac{{V}_{max} - {V}_{be}}{{V}_{min} - {V}_{be}} \cdot \frac{{R}_{Q 1} + {R}_{14} - {R}_{Q 1} + {R}_{Q 2}}{{R}_{Q 1} + {R}_{14}} ; and$$

$$K = \frac{{V}_{max} - {V}_{be}}{{V}_{min} - {V}_{be}} \cdot \frac{{R}_{Q 1} + {R}_{14} - {R}_{Q 1} + {R}_{Q 2}}{{R}_{Q 1} + {R}_{14}} = \frac{{V}_{max} - {V}_{be}}{{V}_{min} - {V}_{be}} \cdot ( 1 - \frac{{R}_{Q 1} - {R}_{Q 2}}{{R}_{Q 1} + {R}_{14}} ) .$$

Since a higher voltage Vₒᵤₜ yields a lower resistance value R_{Q}(Vₒᵤₜ), one obtains R_{Q1}-R_{Q2}=R_{Q}(Vₘᵢₙ)−R_{Q}(Vₘₐₓ)>0.

So, in order to maximize the resistance ratio K, the second term in the second factor needs to be minimized, which is achieved by allowing R₁₄ to approach infinity so that the term goes to zero. In other words, R14 is not needed when optimizing for high values of K, and the expression is then simplified to

$$K = \frac{{V}_{min} - {V}_{be}}{{V}_{max} - {V}_{be}} .$$

The closer Vₘᵢₙ is to V_{be}, the larger K can be, but on the other hand it then also becomes more temperature sensitive since V_{be} depends on the temperature. Therefore, Vₘᵢₙ needs to be set as low as possible, but not lower. This can be determined experimentally by applying temperature variations to the circuit for different values of Vₘᵢₙ. The lower the value for Vₘᵢₙ is allowed to be, the larger K can be, and the larger the value for K, the lower the power losses for high dimming values result. From experiments conducted by the present inventors, a K value of about 10 has been achieved. If the MOSFET gate is modeled as a capacitor C to be charged using a resistance R at voltage V, the voltage V_{C} across the gate becomes

$${V}_{C} = V \cdot ( 1 - exp ( - \frac{t}{R C} ) ) .$$

RC is the time constant for the circuit, which gives an indication of how quickly the capacitor is charged. A K value of 10 therefore means that the time constant is 10 times lower at high dimming values, and since the power losses arise during the transitions when the transistor is opened and closed, these power losses can be decreased considerably.

Regarding the upper part of the circuit in FIG. 18 for the gate drive logic, it is a direct mirror of the lower part, and the same reasoning can be used to derive identical findings.

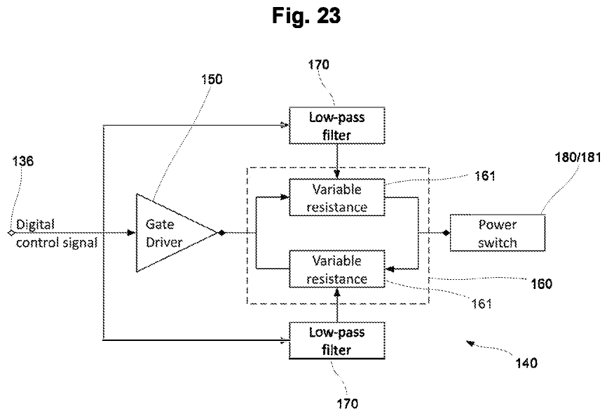

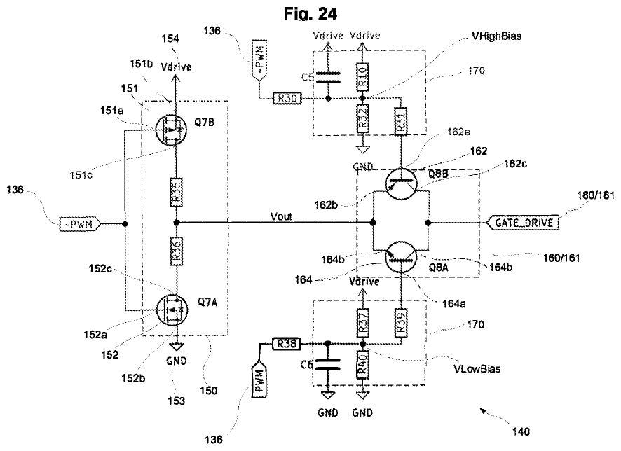

Another possible solution that has similar characteristics as the example provided in FIG. 18 is to separate the gate driver circuit from the variable resistance. By doing so, a conventional gate driver IC can be used in concatenation with a variable resistance, as is illustrated in FIG. 23 (block diagram) and FIG. 24 (detailed circuit example).

In FIG. 24, the left part of the circuit represents a generic gate driver, being arranged to deliver the voltage Vdrive when the binary control signal PWM is high and 0 V when PWM is low. As compared to the circuit shown in FIG. 18, the circuit in FIG. 24 is different, but performs what is basically the same thing, as will now be explained.

Vout is the voltage out from the generic gate driver. In the example shown in FIG. 24, the generic gate driver comprises a push-pull transistor pair 151, 153 (note the correspondence to 151, 153 in FIG. 18), but in other embodiments it could be replaced with a circuit based on, for instance, a BJT transistor pair in common collector or common emitter configuration; an optocoupler; or a gate driver integrated circuit.

By looking at the directions of the BJT transistor arrows, the path of the current through transistors Q8A and/or Q8B can be seen. When Vout is high, the current takes the path through Q8B and when Vout is low, the current takes the path through Q8A.

VHighBias is the potential at the point between resistors R10 and R32, and VLowBias is the potential at the point between R37 and R40. Compare with FIG. 18, where corresponding VHighBias and VLowBias potentials are also marked.

When Vout is high, the current through the base terminal of Q8B is determined by the difference between Vout (that can be, for example, 5V) and VHighBias. The higher this difference is, the higher the current that also goes to GATE_DRIVE. A higher difference is achieved by allowing VHighBias to be lower. As can be seen from FIG. 24, VHighBias is connected via a low-pass filter to ^{~}PWM, so the higher average value of the binary control signal PWM, the lower VHighBias will be, and the more current will go to GATE_DRIVE.

When Vout is low, the current through the base of Q8A is determined by the difference between Vout (that can be, for instance, 0V) and VLowBias. The larger this difference is, the higher the current that goes from GATE_DRIVE. A higher difference is achieved by allowing VLowBias to be higher. As is seen, VLowBias is connected via a low-pass filter to the binary control signal PWM, so the higher the average value of the PWM signal is, the higher VLowBias will be, and the higher the current from GATE_DRIVE will be.

As can be seen when comparing the circuits in FIG. 18 and FIG. 24, the various parts 150, 160, 170 and so forth are arranged differently but with the corresponding function.

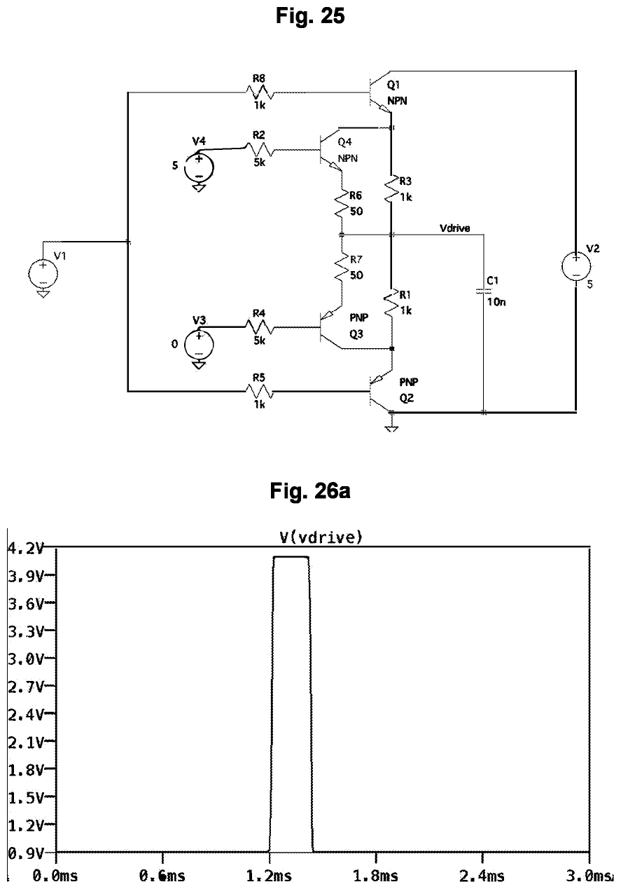

As seen in the above examples, the drive circuit 140 can comprise a push-pull drive circuit based on MOSFETs. However, as is seen in the example of FIG. 25, a corresponding push-pull circuit can instead be designed based on BJTs. In FIG. 25, V3 and V4 are the bias voltages that are generated by low-pass filtering the binary control signal PWM. When V3=0V and V4=5V, the fastest possible control is achieved, as is shown in FIG. 26a. When V3=5V and V4=0V, the slowest possible control is achieved, as is shown in FIG. 26b.

If V3 and V4 are generated by low-pass filtering the inverted binary control signal PWM and the non-inverted binary control signal PWM, respectively, the speed of the switching can be achieved as a function of the duty cycle (as defined above). Hence, the corresponding functionality as in FIGS. 18 and 23 is achieved.

Other possible ways to generate V3 and V4 include that the microcontroller 130 comprises a DAC (Digital to Analog Converter), the outputs of which are used to achieve an even better control over the control signal. A dedicated 2-channel DAC could also be used for each output channel.

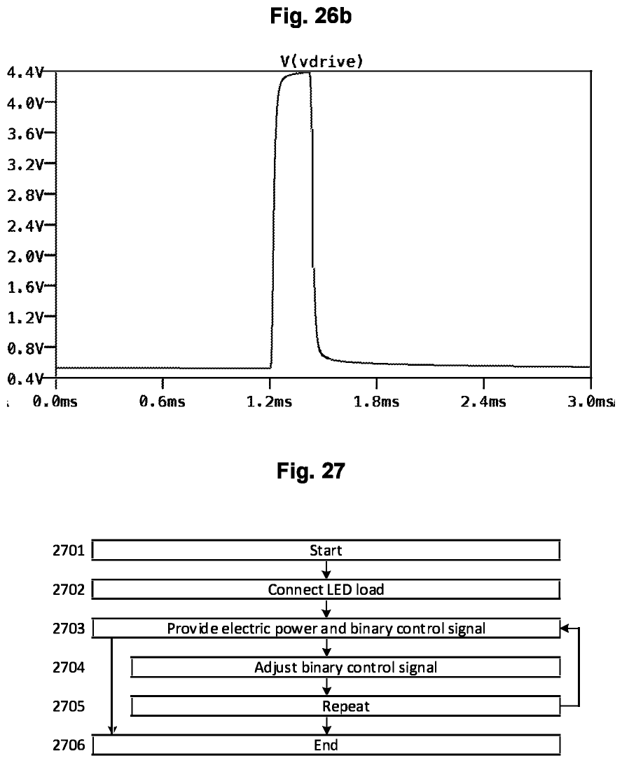

FIG. 27 illustrates a method for driving the LED load 10 using the LED driver 100.

In a first step 2701, the method starts.

In a subsequent step 2702, the driver output 182′ of the LED driver 100 is connected to the LED load 10.

In a subsequent step 2703, electric power is provided to the LED driver 100, such as via the DC bus 121, and the binary control source 136 is caused to provide the binary control signal, in turn causing the power transistor 181 to provide the drive current to the driver output 182′ as described above, resulting in a variable current being provided to the LED load 10 as generally described herein.

In a subsequent step 2704, the binary control signal can be adjusted, such as to reflect a differently set dimming value, thereby modifying the instantaneous time-averaged value. This step can entail mapping the adjusting of the dimming state to a corresponding adjustment of the binary control signal.

In a subsequent step 2705, step 2703 can be repeated but using the updated binary control signal.

In a subsequent step 2706, the method ends.

Above, preferred embodiments have been described. However, it is apparent to the skilled person that many modifications can be made to the disclosed embodiments without departing from the basic idea of the invention.

For instance, the LED driver 100 can comprise various types of additional component parts, in addition to the ones described and exemplified herein. It is also realized that that the examples provided herein are kept simple for reasons of clarity. In various embodiments of the invention, different voltages and currents can be used and applied to the LED load 10.

Generally, all that has been said in relation to the various principles and exemplifying methods and LED drivers 100 described herein can be combined freely, pending compatibility. Moreover, one or several aspects of two or all of the first, second and third aspects described herein can be combined freely in one and the same LED driver or method for operating such an LED driver.

Hence, the invention is not limited to the described embodiments, but can be varied within the scope of the enclosed claims.

1. A method for configuring a Light Emitting Diode (LED) driver for dimming of an LED, the LED driver being arranged to provide a variable current to the LED, a time-average of the variable current corresponding to a dimming value, the variable current being modulated, using a transistor of the LED driver, based on a binary control signal, the binary control signal having a control signal pattern that is repeated over time to form the binary control signal, the control signal pattern at each time having an instantaneous time-averaged value as time-averaged over the control signal pattern used at the time in question, the method comprising:
providing, to a calibration LED or a different calibration load in turn being connected to the LED driver, the variable current with several different instantaneous time-averaged values for the binary control signal;
obtaining, for each of the several different instantaneous time-averaged values, a respective measurement value of a quantity in turn being or being related to at least one of, firstly, an average current flowing through the calibration LED or the calibration load, and, secondly, an average light intensity emitted by the LED, thereby obtaining a measured first relationship of the absolute or relative current/light intensity as a function of the instantaneous time-averaged value;
based on the first relationship, determining configuration information regarding a mapping of each of several different absolute or relative current/light intensity values to a corresponding value for the instantaneous time-averaged value; and
operating the LED driver to drive a different LED, the different LED not being neither the calibration LED nor the calibration load, by determining a binary control signal corresponding to a desired current/light intensity, the determining of the binary control signal being performed using the configuration information, and providing a variable current to a driver output of the LED driver based on the determined binary control signal.

2. The method of claim 1, wherein:
the relative current and/or light intensity is relative to a maximum current or light intensity, respectively.

3. The method of claim 1, further comprising:
identifying a second relationship between the instantaneous time-averaged value and the absolute or relative current/light intensity;
identifying a parametric model of the second relationship, the parametric model comprising one or several at least section-wise continuous functions determined by a set of parameters, the parametric model being useful for determining the mapping of each of the several different absolute or relative current/light intensity values to a corresponding instantaneous time-averaged value; and
determining values of the parameters that provide a fit of the at least one functions to the second relationship, the second relationship being evaluated for each of the measurement values and corresponding instantaneous time-averaged values, and wherein
the configuration information comprises the parameter values.

4. The method of claim 2, wherein:
the second relationship comprises the quote or inverse quote of
$$\frac{g ( x )}{g ( y )} ,$$
wherein
g is a function;
x is the instantaneous time-averaged value; and
y is the absolute or relative current/light intensity.

5. The method of claim 3, wherein:
the one or several functions comprises at least one polynomial of degree 1 or higher.

6. The method of claim 5, wherein:
the one or several functions comprises one polynomial of degree 2 or higher; and/or
the one or several functions comprises two polynomials of degree 1 or higher that are interconnected by multiplication with a sigmoid function.

7. The method of claim 3, wherein:
the one or several functions are defined in terms of a function ƒ(y) where an absolute value of a first derivative of ƒ(y) with respect to y, in other words |ƒ′(y)|, is decreasing, wherein y is the absolute or relative current/light intensity.

8. The method of claim 3, wherein:
the one or several functions comprises a function defined in terms of two different polynomials and a sigmoid function multiplying together the two polynomials; and
the two polynomials are selected to approximate, by selection of the parameter values, a general shape of the second relationship on either side of a local minimum or maximum thereof.

9. The method of claim 8, wherein:
the sigmoid function is defined in terms of two functions s′ and s″ selected to yield a continuous function at an expected local maximum of the second relationship as a function of the absolute or relative current/light intensity, and so that a derivative of the continuous function does not change sign.

10. The method of claim 1, wherein:
the configuration information comprises respective determined and stored configuration information for at least one of:
first, at least two different number of pulses of the control signal pattern;
second, at least two different temperatures of the LED driver when obtaining the measurement values; and
third, at least two different maximum allowed currents to be provided to the LED driver.

11. The method of claim 1, wherein:
the determining of the binary control signal comprises adjusting one or several pulse widths within the binary signal pattern.

12. The method of claim 1, wherein:
the determining of the binary control signal comprises adjusting a number of pulses within the binary signal pattern.

13. The method of claim 12, wherein:
the pulses within the binary signal pattern are adjusted so as to be distributed over a predetermined set of available pulse positions across the binary signal pattern.

14. The method of claim 12, wherein:
the determining of the binary control signal comprises determining a number of pulses within the control signal pattern; and to select the binary control signal according to an interpolation between a first and a second respective expression for the binary control signal,
the first expression for the binary control signal is determined based on the configuration parameters for a first number of pulses within the control signal pattern,
the second expression for the binary control signal is determined based on the configuration parameters for a second number of pulses within the control signal pattern, and
the interpolation is performed for a current number of pulses within the control signal pattern between the first number of pulses and the second number of pulses.

15. The method of claim 14, wherein:
the first and second expressions for the binary control signal are determined based on a respective pulse width within the control signal pattern.

16. The method of claim 14, wherein:
the interpolation is performed using as a weight factor, for the first and second expressions for the binary control signal, a square root of a normalized value for the current number of pulses.
